(19) United States
(12) Patent Application Publication
(10) Pub. No.: US 2025/0299351 A1
(43) Pub. Date: Sep. 25, 2025

(54) DEPTH SEED FUSION FOR DEPTH ESTIMATION

(71) Applicant: QUALCOMM Incorporated, San Diego, CA (US)

(72) Inventors: Qili ZENG, San Diego, CA (US); Khalid TAHBOUB, San Diego, CA (US); Kai WANG, San Diego, CA (US); Hsien-Tzu CHENG, Taipei City (TW); Yen-Yi WU, Taipei City (TW); Anirudh RADHAKRISHNAN, San Diego, CA (US); Abhimanyu KRISHNA, La Jolla, CA (US)

(21) Appl. No.: 18/610,052

(22) Filed: Mar. 19, 2024

(51) Int. Cl. G06T 7/55

(52) U.S. Cl. CPC G06T 7/55; G06T 2207/10028; G06T 2207/20084

(57) ABSTRACT

An example method for estimating depth includes obtaining first depth data from a first depth data source, wherein the first depth data is associated with a first field of view (FOV), obtaining second depth data from a second depth data source, wherein the second depth data is associated with a second FOV, the second FOV being different from the first FOV, generating FOV adjusted depth data based on the second depth data associated with the second FOV, generating a fused depth seed based on the FOV adjusted depth data and at least one of the first depth data or an additional FOV adjusted depth data, and determining a depth map based on the fused depth seed. The FOV adjusted depth data is associated with a target FOV, the target FOV being different from the second FOV. The fused depth seed is associated with the target FOV.

### FIELD

This application is related to depth estimation. More specifically, aspects of the application relate to systems and techniques of depth seed fusion for depth estimation.

### BACKGROUND

Many devices can capture a representation of a scene by generating images (e.g., image frames) and/or video data (including multiple frames) of the scene. For example, a camera or a device including a camera can capture a sequence of frames of a scene (e.g., a video of a scene). In some cases, the sequence of frames can be processed for performing one or more functions, can be output for display, can be output for processing and/or consumption by other devices, among other uses.

Degrees of freedom (DoF) refer to the number of basic ways a rigid object can move through three-dimensional (3D) space. In some examples, six different DoF can be tracked. The six DoF include three translational DoF corresponding to translational movement along three perpendicular axes, which can be referred to as x, y, and z axes. The six DoF include three rotational DoF corresponding to rotational movement around the three axes, which can be referred to as pitch, yaw, and roll. Some extended reality (XR) devices, such as virtual reality (VR) or augmented reality (AR) headsets, can track some or all of these degrees of freedom. For instance, a 3DoF XR headset typically tracks the three rotational DoF, and can therefore track whether a user turns and/or tilts their head. A 6DoF XR headset tracks all six DoF, and thus also tracks a user's translational movements.

### SUMMARY

Systems and techniques are described herein for estimating depth. According to at least one example, a method is provided for estimating depth. The method includes: obtaining first depth data from a first depth data source, wherein the first depth data is associated with a first field of view (FOV); obtaining second depth data from a second depth data source, wherein the second depth data is associated with a second FOV, the second FOV being different from the first FOV; generating FOV adjusted depth data based on the second depth data associated with the second FOV, wherein the FOV adjusted depth data is associated with a target FOV, the target FOV being different from the second FOV; generating a fused depth seed based on the FOV adjusted depth data and at least one of the first depth data or an additional FOV adjusted depth data, wherein the fused depth seed is associated with the target FOV; and determining a depth map based on the fused depth seed.

In another example, an apparatus for depth estimation is provided that includes at least one memory and at least one processor (e.g., implemented in circuitry) coupled to the at least one memory. The at least one processor is configured to and can: obtain first depth data from a first depth data source, wherein the first depth data is associated with a first FOV; obtain second depth data from a second depth data source, wherein the second depth data is associated with a second FOV, the second FOV being different from the first FOV; generate FOV adjusted depth data based on the second depth data associated with the second FOV, wherein the FOV adjusted depth data is associated with a target FOV, the target FOV being different from the second FOV; generate a fused depth seed based on the FOV adjusted depth data and at least one of the first depth data or an additional FOV adjusted depth data, wherein the fused depth seed is associated with the target FOV; and determine a depth map based on the fused depth seed.

In another example, a non-transitory computer-readable medium is provided that has stored thereon instructions that, when executed by one or more processors, cause the one or more processors to: obtain first depth data from a first depth data source, wherein the first depth data is associated with a first FOV; obtain second depth data from a second depth data source, wherein the second depth data is associated with a second FOV, the second FOV being different from the first FOV; generate FOV adjusted depth data based on the second depth data associated with the second FOV, wherein the FOV adjusted depth data is associated with a target FOV, the target FOV being different from the second FOV; generate a fused depth seed based on the FOV adjusted depth data and at least one of the first depth data or an additional FOV adjusted depth data, wherein the fused depth seed is associated with the target FOV; and determine a depth map based on the fused depth seed.

In accordance with another embodiment of the present disclosure, an apparatus for calibrating a phased array antenna is provided. The apparatus includes: means for obtaining first depth data from a first depth data source, wherein the first depth data is associated with a first FOV; means for obtaining second depth data from a second depth data source, wherein the second depth data is associated with a second FOV, the second FOV being different from the first FOV; means for generating FOV adjusted depth data based on the second depth data associated with the second FOV, wherein the FOV adjusted depth data is associated with a target FOV, the target FOV being different from the second FOV; means for generating a fused depth seed based on the FOV adjusted depth data and at least one of the first depth data or an additional FOV adjusted depth data, wherein the fused depth seed is associated with the target FOV; and means for determining a depth map based on the fused depth seed.

In some aspects, the apparatus comprises a camera, a mobile device (e.g., a mobile telephone or so-called “smart phone” or other mobile device), a wireless communication device, a wearable device, an extended reality device (e.g., a virtual reality (VR) device, an augmented reality (AR) device, or a mixed reality (MR) device), a personal computer, a laptop computer, a server computer, or other device. In some aspects, the one or more processors include an image signal processor (ISP). In some aspects, the apparatus includes a camera or multiple cameras for capturing one or more images. In some aspects, the apparatus includes an image sensor that captures the image data. In some aspects, the apparatus further includes a display for displaying the image, one or more notifications (e.g., associated with processing of the image), and/or other displayable data.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and embodiments, will become more apparent upon referring to the following specification, claims, and accompanying drawings.

### BRIEF DESCRIPTION OF THE DRAWINGS

Illustrative embodiments of the present application are described in detail below with reference to the following figures:

FIG. 1 is a block diagram illustrating an architecture of an image capture and processing device, in accordance with some examples of the present disclosure;

FIG. 2 is a block diagram illustrating an architecture of an example extended reality (XR) system, in accordance with some examples of the present disclosure;

FIG. 3 is a block diagram illustrating an architecture of a simultaneous localization and mapping (SLAM) device, in accordance with some examples of the present disclosure;

FIG. 4A is a block diagram illustrating an example architecture of a depth seed fusion system, in accordance with some examples of the present disclosure;

FIG. 4B is a block diagram illustrating an example architecture of a depth seed fusion system with depth seed adjustment, in accordance with some examples of the present disclosure;

FIG. 5A is a block diagram illustrating generation of a sparse depth seed based on time of flight (ToF), in accordance with some examples of the present disclosure;

FIG. 5B is a block diagram illustrating generation of a sparse depth seed based on depth from stereo (DFS), in accordance with some examples of the present disclosure;

FIG. 6 is a flow diagram illustrating an example of an image processing technique, in accordance with some examples of the present disclosure;

FIG. 7A is a perspective diagram illustrating an unmanned ground vehicle (UGV) that performs feature tracking and/or visual simultaneous localization and mapping (VSLAM), in accordance with some examples of the present disclosure;

FIG. 7B is a perspective diagram illustrating an unmanned aerial vehicle (UAV) that performs feature tracking and/or visual simultaneous localization and mapping (VSLAM, in accordance with some examples of the present disclosure;

FIG. 8A is a perspective diagram illustrating a head-mounted display (HMD) that performs feature tracking and/or visual simultaneous localization and mapping (VSLAM, in accordance with some examples of the present disclosure;

FIG. 8B is a perspective diagram illustrating the head-mounted display (HMD) of FIG. 8A being worn by a user, in accordance with some examples of the present disclosure;

FIG. 9A is a perspective diagram illustrating a front surface of a mobile handset that performs feature tracking and/or visual simultaneous localization and mapping (VSLAM) using one or more front-facing cameras, in accordance with some examples of the present disclosure;

FIG. 9B is a perspective diagram illustrating a rear surface of a mobile handset that performs feature tracking and/or visual simultaneous localization and mapping (VSLAM) using one or more rear-facing cameras, in accordance with some examples of the present disclosure;

FIG. 10 is a block diagram illustrating an example of a deep learning network, in accordance with some examples;

FIG. 11 is a block diagram illustrating an example of a convolutional neural network, in accordance with some examples;

FIG. 12 is a diagram illustrating an example of a system for implementing certain aspects of the present technology.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the application as set forth in the appended claims.

Visual simultaneous localization and mapping (VSLAM) is a computational geometry technique used in devices with cameras, such as robots, head-mounted displays (HMDs), mobile handsets, and autonomous vehicles. In VSLAM, a device can construct and update a map of an unknown environment based on images captured by the device's camera. The device can keep track of the device's pose within the environment (e.g., location and/or orientation) as the device updates the map. For example, the device can be activated in a particular room of a building and can move throughout the interior of the building, capturing images. The device can map the environment, and keep track of its location in the environment, based on tracking where different objects in the environment appear in different images.

In some implementations, the output of one or more sensors (e.g., an accelerometer, a gyroscope, one or more inertial measurement units (IMUs), and/or other sensors) can be used to determine a pose of a device (e.g., HMD, mobile device, or the like). An IMU is an electronic device that measures the specific force, angular rate, and/or the orientation of an electronic device, using a combination of one or more accelerometers, one or more gyroscopes, and/or one or more magnetometers. In some examples, the one or more sensors can output measured information associated with the capture of an image captured by a camera of the device (e.g., the HMD, the mobile device, or the like) and/or depth information obtained using one or more depth sensors of the device.

In the context of systems that track movement through an environment, such as XR systems and/or VSLAM systems, degrees of freedom (DoF) can refer to which of the six degrees of freedom the system is capable of tracking. 3DoF systems generally track the three rotational DoF—pitch, yaw, and roll. A 3DoF headset, for instance, can track the user of the headset turning their head left or right, tilting their head up or down, and/or tilting their head to the left or right. 6DoF systems can track the three translational DoF as well as the three rotational DoF. Thus, a 6DoF headset, for instance, and can track the user moving forward, backward, laterally, and/or vertically in addition to tracking the three rotational DoF.

Extended reality (XR) devices are an example of devices that can perform complex functions and display an output based on those functions. XR devices can include augmented reality (AR) devices, virtual reality (VR) devices, mixed reality (MR) devices, or the like. Examples of XR systems or devices include head-mounted displays (HMDs), smart glasses, among others. As used herein, the terms XR system and XR device are used interchangeably.

Systems that track movement through an environment, such as XR systems and/or VSLAM systems, generally include powerful processors. These powerful processors can be used to perform complex operations quickly enough to display an up-to-date output based on those operations to the users of these systems. Such complex operations can relate to feature tracking, 6DoF tracking, VSLAM, rendering virtual objects to overlay over the user's environment in XR, animating the virtual objects, and/or other operations discussed herein. Powerful processors typically draw power at a high rate. Sending large quantities of data to powerful processors typically draws power at a high rate, and such systems often capture large quantities of sensor data (e.g., images, location data, and/or other sensor data) per second. Headsets and other portable devices typically have small batteries so as not to be uncomfortably heavy to users. Thus, typical XR headsets either must be plugged into an external power source, are uncomfortably heavy due to inclusion of large batteries, or have very short battery lives.

XR systems or devices can provide virtual content to a user and/or can combine real-world or physical environments and virtual environments (made up of virtual content) to provide users with XR experiences. The real-world environment can include real-world objects (also referred to as physical objects), such as people, vehicles, buildings, tables, chairs, and/or other real-world or physical objects. In some cases, an XR system can track parts of the user (e.g., a hand and/or fingertips of a user) to allow the user to interact with items of virtual content. XR systems or devices can facilitate interaction with different types of XR environments (e.g., a user can use an XR system or device to interact with an XR environment). XR systems can include VR systems facilitating interactions with VR environments, AR systems facilitating interactions with AR environments, MR systems facilitating interactions with MR environments, and/or other XR systems.

For example, an AR device can implement cameras and a variety of sensors to track the position of the AR device and other objects within the physical environment. An AR device can use the tracking information to provide a user of the AR device a realistic AR experience. For example, an AR device can allow a user to experience or interact with immersive virtual environments or content. To provide realistic AR experiences, AR technologies generally aim to integrate virtual content with the physical world. In some examples, AR technologies can match the relative pose and movement of objects and devices. For example, an AR device can use tracking information to calculate the relative pose of devices, objects, and/or maps of the real-world environment in order to match the relative position and movement of the devices, objects, and/or the real-world environment. The relative pose information can be used to match virtual content with the user's perceived motion and the spatio-temporal state of the devices, objects, and real-world environment. Using the pose and movement of one or more devices, objects, and/or the real-world environment, the AR device can display virtual content relative to the real-world environment in a convincing manner. In one illustrative example, the AR device can anchor virtual content to the real-world environment.

Machine learning systems (e.g., deep neural network systems or models) can be used to perform a variety of tasks such as, for example, detection and/or recognition (e.g., scene or object detection and/or recognition, face detection and/or recognition, etc.), depth estimation, pose estimation, image reconstruction, classification, three-dimensional (3D) modeling, dense regression tasks, data compression and/or decompression, and image processing, among other tasks. Moreover, machine learning models can be versatile and can achieve high quality results in a variety of tasks.

In some cases, a machine learning system can perform depth estimation based on a single image (e.g., based on receiving a single image as input). Depth estimation based on a single input image can be referred to as monocular depth estimation. Depth estimation based on a pair of stereoscopic images (e.g., corresponding to two slightly different views of the same scene) can be referred to as stereo depth estimation and/or depth-from-stereo (DFS).

Different types of neural networks exist, such as deep generative neural network models (e.g., generative adversarial network (GANs)), recurrent neural network (RNN) models, multilayer perceptron (MLP) neural network models, convolutional neural network (CNN) models, among others. A GAN is a form of generative neural network that can learn patterns in input data so that the neural network model can generate new synthetic outputs that reasonably could have been from the original dataset. A GAN can include two neural networks that operate together. One of the neural networks (referred to as a generative neural network or generator denoted as G(z)) generates a synthesized output, and the other neural network (referred to as a discriminative neural network or discriminator denoted as D(X)) evaluates the output for authenticity (whether the output is from an original dataset, such as the training dataset, or is generated by the generator). The training input and output can include images as an illustrative example. The generator is trained to try and fool the discriminator into determining a synthesized image generated by the generator is a real image from the dataset. The training process continues and the generator becomes better at generating the synthetic images that look like real images. The discriminator continues to find flaws in the synthesized images, and the generator figures out what the discriminator is looking at to determine the flaws in the images. Once the network is trained, the generator is able to produce realistic looking images that the discriminator is unable to distinguish from the real images.

RNNs work on the principle of saving the output of a layer and feeding this output back to the input to help in predicting an outcome of the layer. In MLP neural networks, data may be fed into an input layer, and one or more hidden layers provide levels of abstraction to the data. Predictions may then be made on an output layer based on the abstracted data. MLPs may be particularly suitable for classification prediction problems where inputs are assigned a class or label. Convolutional neural networks (CNNs) are a type of feed-forward artificial neural network. CNNs may include collections of artificial neurons that each have a receptive field (e.g., a spatially localized region of an input space) and that collectively tile an input space. CNNs have numerous applications, including pattern recognition and classification.

In layered neural network architectures (referred to as deep neural networks when multiple hidden layers are present), the output of a first layer of artificial neurons becomes an input to a second layer of artificial neurons, the output of a second layer of artificial neurons becomes an input to a third layer of artificial neurons, and so on. Convolutional neural networks may be trained to recognize a hierarchy of features. Computation in convolutional neural network architectures may be distributed over a population of processing nodes, which may be configured in one or more computational chains. These multi-layered architectures may be trained one layer at a time and may be fine-tuned using back propagation.

Depth estimation can be used for many applications (e.g., extended reality (XR) applications, vehicle applications, image-modification applications, such as artificial green-screen applications and/or synthetic bokeh applications, etc.). In some cases, depth estimation can be used to perform occlusion rendering, for example based on using depth and/or object segmentation information to render virtual objects in a 3D environment. In some cases, depth estimation can be used to perform 3D reconstruction, for example based on using depth information and one or more poses to create a mesh of a scene. In some cases, depth estimation can be used to perform collision avoidance, for example based on using depth information to estimate distance(s) to one or more objects.

Depth estimation can be used to generate three-dimensional content (e.g., such as XR content) with greater accuracy. For instance, depth estimation can be used to generate XR content that combines a baseline image or video with one or more augmented overlays of rendered 3D objects. The baseline image data (e.g., an image or a frame of video) that is augmented or overlaid by an XR system (e.g., VR system, AR system, and/or MR system) may be a two-dimensional (2D) representation of a 3D scene. A naïve approach to generating XR content may be to overlay a rendered object onto the baseline image data, without compensating for 3D depth information that may be represented in the 2D baseline image data.

Depth and/or disparity information can be obtained from one or more depth sensors which can include, but are not limited to, Time of Flight (ToF) sensors, light-based or range-based sensors, etc. Depth and/or disparity information can additionally, or alternatively, be obtained as a prediction or estimation that is generated based on one or more image inputs, depth inputs, etc. Accurate depth and/or disparity information can be used for various applications or systems. For instance, depth and/or disparity information can be used for vehicles to perceive a driving scene and surrounding environment, and to estimate the distances between the vehicle and surrounding environmental objects (e.g., other vehicles, pedestrians, roadway elements, etc.). Accurate depth and/or disparity information may be needed for the vehicle to determine and perform appropriate control actions, such as velocity control, steering control, braking control, etc.

Depth information can also be used in robotics to perform functions such as navigation, localization, and interaction with physical objects in the robot's surrounding environment, among various other functions. For example, accurate depth information can be needed to provide improved navigation, localization, and interaction between robots and their surrounding environment (e.g., to avoid colliding with obstacles, nearby humans, etc.).

In another example, depth information can be used for image enhancement and/or other image manipulation applications or functions. For instance, depth information can be used to differentiate foreground and background portions of an image, which can subsequently be processed, manipulated, enhanced, etc., separately. In one illustrative example, depth information can be used to generate a bokeh effect that simulates an image taken with a low aperture value (e.g., a large physical aperture size), where the foreground of the image is sharply in focus while the background of the image is blurred (e.g., out of focus). Additionally or alternatively, depth information can be used for artificial-green-screen effects in which a background of a scene is replaced by another image.

In another example, depth and/or disparity information can be used for extended reality (XR) applications for functions such as indoor scene reconstruction and obstacle detection for users, among various others. For instance, accurate depth information can be needed for improved integration of real scenes with virtual scenes and/or to allow users to smoothly and safely interact with both their real-world surroundings and the XR or VR environment. For at least the reasons discussed above, systems and techniques are needed for accurate and reliable depth estimation.

As described in more detail herein, systems, apparatuses, methods (also referred to as processes, and computer-readable media (collectively referred to herein as “systems and techniques”) are described for depth estimation. Various depth estimation techniques have been developed for estimating depth (e.g., distance) of an object. For example, without limitation, depth estimation techniques can include 6DoF tracking, 3DoF, SLAM (e.g., VSLAM), DFS, direct time of flight (dToF), indirect time of flight (iToF), structured light (SL) depth sensing, radars, light detection and ranging (LIDAR), radio detection and ranging (RADAR), sound detection and ranging (SODAR), sound navigation and ranging (SONAR), and/or any combination thereof. In some cases, different depth estimation techniques can present different strengths and weaknesses. For example, DFS-based depth sensing can produce inaccurate and/or low confidence depth values on texture-less surfaces and/or distance objects. As another example, LiDAR sensors may produce inaccurate and/or low confidence depth values on specular surfaces and/or translucent objects.

In some cases, a machine learning model (e.g., a deep learning neural network) can be utilized to determine a dense depth map based on an input frame (e.g., from a camera of an XR system). In some cases, a sparse depth seed can be obtained using a depth estimation technique and filtering depth data from the depth estimation technique to include depth values with a high confidence value. However, if only a single depth estimation technique is used to generate the sparse depth seed, the sparse depth seed can be unstable, low-confidence and/or excessively sparse depending on the contents of the input frame and the strengths and weaknesses of the depth estimation technique used. In some cases, the quality of depth estimates contained in a dense depth map determined by the machine learning model can suffer is the sparse depth seed is unstable, low-confidence, and/or excessively sparse. Accordingly, the systems and techniques described herein include fusing sparse depth seeds obtained from multiple depth estimation techniques. In some examples, by fusing sparse depth seeds from multiple depth estimation techniques, high quality sparse depth seeds can be obtained even when one or more of the spare depth seeds is unstable, low-confidence, and/or excessively sparse.

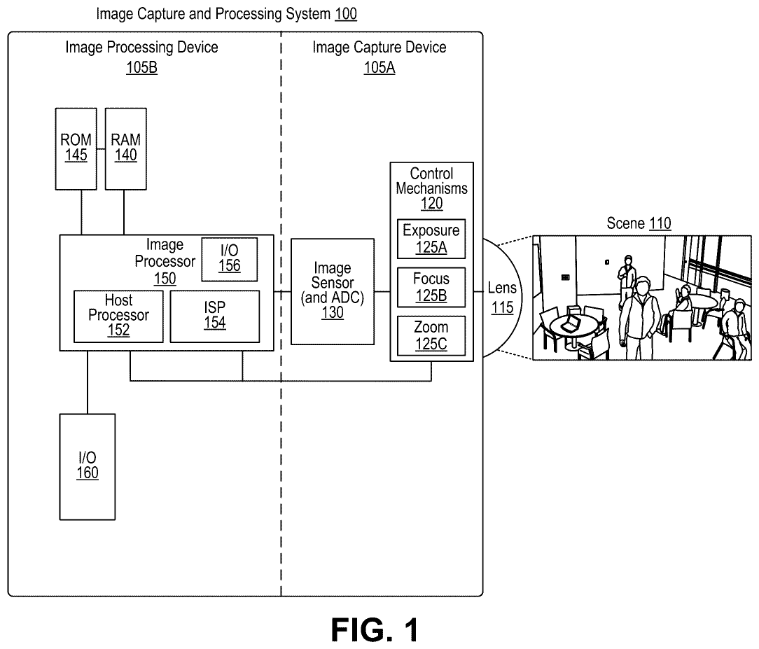

Various aspects of the application will be described with respect to the figures. FIG. 1 is a block diagram illustrating an architecture of an image capture and processing system 100. The image capture and processing system 100 includes various components that are used to capture and process images of scenes (e.g., an image of a scene 110). The image capture and processing system 100 can capture standalone images (or photographs) and/or can capture videos that include multiple images (or video frames) in a particular sequence. In some cases, the lens 115 and image sensor 130 can be associated with an optical axis. In one illustrative example, the photosensitive area of the image sensor 130 (e.g., the photodiodes) and the lens 115 can both be centered on the optical axis. A lens 115 of the image capture and processing system 100 faces a scene 110 and receives light from the scene 110. The lens 115 bends incoming light from the scene toward the image sensor 130. The light received by the lens 115 passes through an aperture. In some cases, the aperture (e.g., the aperture size) is controlled by one or more control mechanisms 120 and is received by an image sensor 130. In some cases, the aperture can have a fixed size.

The one or more control mechanisms 120 may control exposure, focus, and/or zoom based on information from the image sensor 130 and/or based on information from the image processor 150. The one or more control mechanisms 120 may include multiple mechanisms and components; for instance, the control mechanisms 120 may include one or more exposure control mechanisms 125A, one or more focus control mechanisms 125B, and/or one or more zoom control mechanisms 125C. The one or more control mechanisms 120 may also include additional control mechanisms besides those that are illustrated, such as control mechanisms controlling analog gain, flash, HDR, depth of field, and/or other image capture properties.

The focus control mechanism 125B of the control mechanisms 120 can obtain a focus setting. In some examples, focus control mechanism 125B store the focus setting in a memory register. Based on the focus setting, the focus control mechanism 125B can adjust the position of the lens 115 relative to the position of the image sensor 130. For example, based on the focus setting, the focus control mechanism 125B can move the lens 115 closer to the image sensor 130 or farther from the image sensor 130 by actuating a motor or servo (or other lens mechanism), thereby adjusting focus. In some cases, additional lenses may be included in the image capture and processing system 100, such as one or more microlenses over each photodiode of the image sensor 130, which each bend the light received from the lens 115 toward the corresponding photodiode before the light reaches the photodiode. The focus setting may be determined via contrast detection autofocus (CDAF), phase detection autofocus (PDAF), hybrid autofocus (HAF), or some combination thereof. The focus setting may be determined using the control mechanism 120, the image sensor 130, and/or the image processor 150. The focus setting may be referred to as an image capture setting and/or an image processing setting. In some cases, the lens 115 can be fixed relative to the image sensor and focus control mechanism 125B can be omitted without departing from the scope of the present disclosure.

The exposure control mechanism 125A of the control mechanisms 120 can obtain an exposure setting. In some cases, the exposure control mechanism 125A stores the exposure setting in a memory register. Based on this exposure setting, the exposure control mechanism 125A can control a size of the aperture (e.g., aperture size or f/stop), a duration of time for which the aperture is open (e.g., exposure time or shutter speed), a duration of time for which the sensor collects light (e.g., exposure time or electronic shutter speed), a sensitivity of the image sensor 130 (e.g., ISO speed or film speed), analog gain applied by the image sensor 130, or any combination thereof. The exposure setting may be referred to as an image capture setting and/or an image processing setting.

The zoom control mechanism 125C of the control mechanisms 120 can obtain a zoom setting. In some examples, the zoom control mechanism 125C stores the zoom setting in a memory register. Based on the zoom setting, the zoom control mechanism 125C can control a focal length of an assembly of lens elements (lens assembly) that includes the lens 115 and one or more additional lenses. For example, the zoom control mechanism 125C can control the focal length of the lens assembly by actuating one or more motors or servos (or other lens mechanism) to move one or more of the lenses relative to one another. The zoom setting may be referred to as an image capture setting and/or an image processing setting. In some examples, the lens assembly may include a parfocal zoom lens or a varifocal zoom lens. In some examples, the lens assembly may include a focusing lens (which can be lens 115 in some cases) that receives the light from the scene 110 first, with the light then passing through an afocal zoom system between the focusing lens (e.g., lens 115) and the image sensor 130 before the light reaches the image sensor 130. The afocal zoom system may, in some cases, include two positive (e.g., converging, convex) lenses of equal or similar focal length (e.g., within a threshold difference of one another) with a negative (e.g., diverging, concave) lens between them. In some cases, the zoom control mechanism 125C moves one or more of the lenses in the afocal zoom system, such as the negative lens and one or both of the positive lenses. In some cases, zoom control mechanism 125C can control the zoom by capturing an image from an image sensor of a plurality of image sensors (e.g., including image sensor 130) with a zoom corresponding to the zoom setting. For example, image processing system 100 can include a wide angle image sensor with a relatively low zoom and a telephoto image sensor with a greater zoom. In some cases, based on the selected zoom setting, the zoom control mechanism 125C can capture images from a corresponding sensor.

The image sensor 130 includes one or more arrays of photodiodes or other photosensitive elements. Each photodiode measures an amount of light that eventually corresponds to a particular pixel in the image produced by the image sensor 130. In some cases, different photodiodes may be covered by different filters. In some cases, different photodiodes can be covered in color filters, and may thus measure light matching the color of the filter covering the photodiode. Various color filter arrays can be used, including a Bayer color filter array, a quad color filter array (also referred to as a quad Bayer color filter array or QCFA), and/or any other color filter array. For instance, Bayer color filters include red color filters, blue color filters, and green color filters, with each pixel of the image generated based on red light data from at least one photodiode covered in a red color filter, blue light data from at least one photodiode covered in a blue color filter, and green light data from at least one photodiode covered in a green color filter.

Returning to FIG. 1, other types of color filters may use yellow, magenta, and/or cyan (also referred to as “emerald”) color filters instead of or in addition to red, blue, and/or green color filters. In some cases, some photodiodes may be configured to measure infrared (IR) light. In some implementations, photodiodes measuring IR light may not be covered by any filter, thus allowing IR photodiodes to measure both visible (e.g., color) and IR light. In some examples, IR photodiodes may be covered by an IR filter, allowing IR light to pass through and blocking light from other parts of the frequency spectrum (e.g., visible light, color). Some image sensors (e.g., image sensor 130) may lack filters (e.g., color, IR, or any other part of the light spectrum) altogether and may instead use different photodiodes throughout the pixel array (in some cases vertically stacked). The different photodiodes throughout the pixel array can have different spectral sensitivity curves, therefore responding to different wavelengths of light. Monochrome image sensors may also lack filters and therefore lack color depth.

In some cases, the image sensor 130 may alternately or additionally include opaque and/or reflective masks that block light from reaching certain photodiodes, or portions of certain photodiodes, at certain times and/or from certain angles. In some cases, opaque and/or reflective masks may be used for phase detection autofocus (PDAF). In some cases, the opaque and/or reflective masks may be used to block portions of the electromagnetic spectrum from reaching the photodiodes of the image sensor (e.g., an IR cut filter, a UV cut filter, a band-pass filter, low-pass filter, high-pass filter, or the like). The image sensor 130 may also include an analog gain amplifier to amplify the analog signals output by the photodiodes and/or an analog to digital converter (ADC) to convert the analog signals output of the photodiodes (and/or amplified by the analog gain amplifier) into digital signals. In some cases, certain components or functions discussed with respect to one or more of the control mechanisms 120 may be included instead or additionally in the image sensor 130. The image sensor 130 may be a charge-coupled device (CCD) sensor, an electron-multiplying CCD (EMCCD) sensor, an active-pixel sensor (APS), a complimentary metal-oxide semiconductor (CMOS), an N-type metal-oxide semiconductor (NMOS), a hybrid CCD/CMOS sensor (e.g., sCMOS), or some other combination thereof.

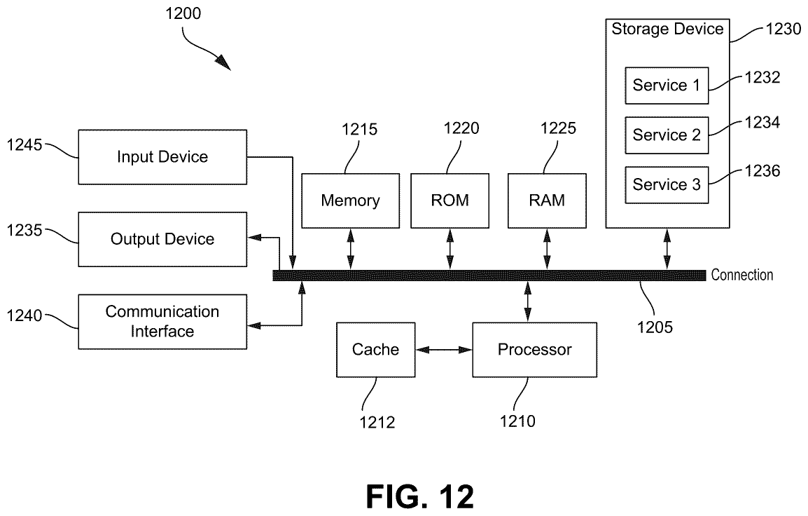

The image processor 150 may include one or more processors, such as one or more image signal processors (ISPs) (including ISP 154), one or more host processors (including host processor 152), and/or one or more of any other type of processor 1210 discussed with respect to the computing system 1200 of FIG. 12. The host processor 152 can be a digital signal processor (DSP) and/or other type of processor. In some implementations, the image processor 150 is a single integrated circuit or chip (e.g., referred to as a system-on-chip or SoC) that includes the host processor 152 and the ISP 154. In some cases, the chip can also include one or more input/output ports (e.g., input/output (I/O) ports 156), central processing units (CPUs), graphics processing units (GPUs), broadband modems (e.g., 3G, 4G or LTE, 5G, etc.), memory, connectivity components (e.g., Bluetooth™, Global Positioning System (GPS), etc.), any combination thereof, and/or other components. The I/O ports 156 can include any suitable input/output ports or interface according to one or more protocol or specification, such as an Inter-Integrated Circuit 2 (I2C) interface, an Inter-Integrated Circuit 3 (I3C) interface, a Serial Peripheral Interface (SPI) interface, a serial General Purpose Input/Output (GPIO) interface, a Mobile Industry Processor Interface (MIPI) (such as a MIPI CSI-2 physical (PHY) layer port or interface, an Advanced High-performance Bus (AHB) bus, any combination thereof, and/or other input/output port. In one illustrative example, the host processor 152 can communicate with the image sensor 130 using an I2C port, and the ISP 154 can communicate with the image sensor 130 using an MIPI port.

The image processor 150 may perform a number of tasks, such as de-mosaicing, color space conversion, image frame downsampling, pixel interpolation, automatic exposure (AE) control, automatic gain control (AGC), CDAF, PDAF, automatic white balance, merging of image frames to form an HDR image, image recognition, object recognition, feature recognition, receipt of inputs, managing outputs, managing memory, or some combination thereof. The image processor 150 may store image frames and/or processed images in random access memory (RAM) 140/1025, read-only memory (ROM) 145/1020, a cache, a memory unit, another storage device, or some combination thereof.

Various input/output (I/O) devices 160 may be connected to the image processor 150. The I/O devices 160 can include a display screen, a keyboard, a keypad, a touchscreen, a trackpad, a touch-sensitive surface, a printer, any other output devices 1035, any other input devices 1045, or some combination thereof. In some cases, a caption may be input into the image processing device 105B through a physical keyboard or keypad of the I/O devices 160, or through a virtual keyboard or keypad of a touchscreen of the I/O devices 160. The I/O 160 may include one or more ports, jacks, or other connectors that enable a wired connection between the image capture and processing system 100 and one or more peripheral devices, over which the image capture and processing system 100 may receive data from the one or more peripheral device and/or transmit data to the one or more peripheral devices. The I/O 160 may include one or more wireless transceivers that enable a wireless connection between the image capture and processing system 100 and one or more peripheral devices, over which the image capture and processing system 100 may receive data from the one or more peripheral device and/or transmit data to the one or more peripheral devices. The peripheral devices may include any of the previously-discussed types of I/O devices 160 and may themselves be considered I/O devices 160 once they are coupled to the ports, jacks, wireless transceivers, or other wired and/or wireless connectors.

In some cases, the image capture and processing system 100 may be a single device. In some cases, the image capture and processing system 100 may be two or more separate devices, including an image capture device 105A (e.g., a camera) and an image processing device 105B (e.g., a computing device coupled to the camera). In some implementations, the image capture device 105A and the image processing device 105B may be coupled together, for example via one or more wires, cables, or other electrical connectors, and/or wirelessly via one or more wireless transceivers. In some implementations, the image capture device 105A and the image processing device 105B may be disconnected from one another.

As shown in FIG. 1, a vertical dashed line divides the image capture and processing system 100 of FIG. 1 into two portions that represent the image capture device 105A and the image processing device 105B, respectively. The image capture device 105A includes the lens 115, control mechanisms 120, and the image sensor 130. The image processing device 105B includes the image processor 150 (including the ISP 154 and the host processor 152), the RAM 140, the ROM 145, and the I/O 160. In some cases, certain components illustrated in the image processing device 105B, such as the ISP 154 and/or the host processor 152, may be included in the image capture device 105A.

The image capture and processing system 100 can include an electronic device, such as a mobile or stationary telephone handset (e.g., smartphone, cellular telephone, or the like), a desktop computer, a laptop or notebook computer, a tablet computer, a set-top box, a television, a camera, a display device, a digital media player, a video gaming console, a video streaming device, an Internet Protocol (IP) camera, or any other suitable electronic device. In some examples, the image capture and processing system 100 can include one or more wireless transceivers for wireless communications, such as cellular network communications, 1002.11 wi-fi communications, wireless local area network (WLAN) communications, or some combination thereof. In some implementations, the image capture device 105A and the image processing device 105B can be different devices. For instance, the image capture device 105A can include a camera device and the image processing device 105B can include a computing device, such as a mobile handset, a desktop computer, or other computing device.

While the image capture and processing system 100 is shown to include certain components, one of ordinary skill will appreciate that the image capture and processing system 100 can include more or fewer components than those shown in FIG. 1. In some cases, the image capture and processing system 100 can include software, hardware, or one or more combinations of software and hardware. For example, in some implementations, the components of the image capture and processing system 100 can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein. The software and/or firmware can include one or more instructions stored on a computer-readable storage medium and executable by one or more processors of the electronic device implementing the image capture and processing system 100.

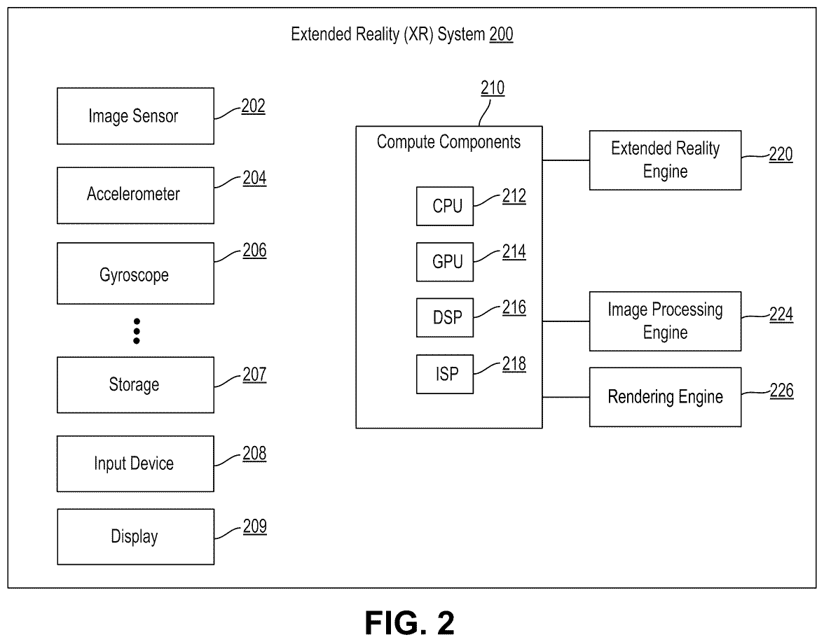

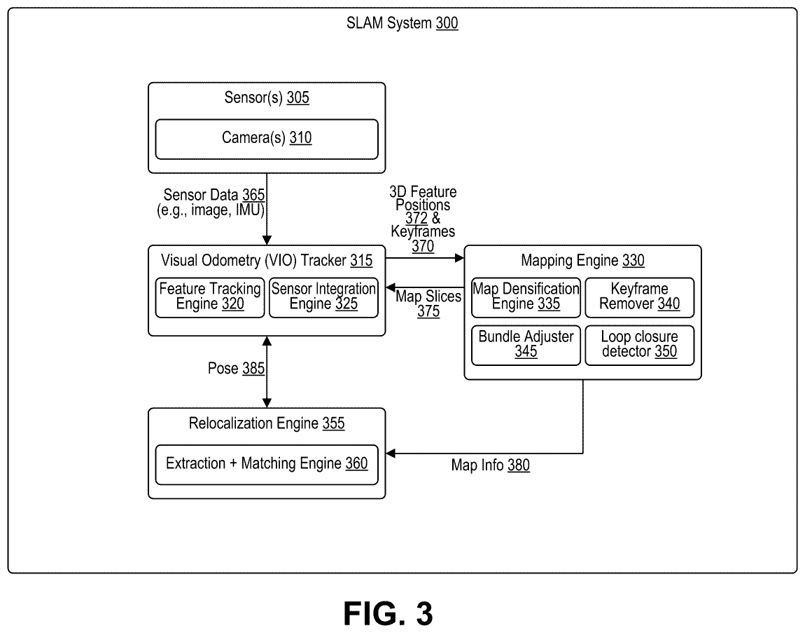

In some examples, the extended reality (XR) system 200 of FIG. 2 can include the image capture and processing system 100, the image capture device 105A, the image processing device 105B, or a combination thereof. In some examples, the simultaneous localization and mapping (SLAM) system 300 of FIG. 3 can include the image capture and processing system 100, the image capture device 105A, the image processing device 105B, or a combination thereof.

FIG. 2 is a diagram illustrating an architecture of an example XR system 200, in accordance with some aspects of the disclosure. The XR system 200 can run (or execute) XR applications and implement XR operations. In some examples, the XR system 200 can perform tracking and localization, mapping of an environment in the physical world (e.g., a scene), and/or positioning and rendering of virtual content on a display 209 (e.g., a screen, visible plane/region, and/or other display) as part of an XR experience. For example, the XR system 200 can generate a map (e.g., a three-dimensional (3D) map) of an environment in the physical world, track a pose (e.g., location and position) of the XR system 200 relative to the environment (e.g., relative to the 3D map of the environment), position and/or anchor virtual content in a specific location(s) on the map of the environment, and render the virtual content on the display 209 such that the virtual content appears to be at a location in the environment corresponding to the specific location on the map of the scene where the virtual content is positioned and/or anchored. The display 209 can include a glass, a screen, a lens, a projector, and/or other display mechanism that allows a user to see the real-world environment and also allows XR content to be overlaid, overlapped, blended with, or otherwise displayed thereon.

In this illustrative example, the XR system 200 includes one or more image sensors 202, an accelerometer 204, a gyroscope 206, storage 207, compute components 210, an XR engine 220, an image processing engine 224, a visual alignment engine 225, a rendering engine 226, and a communications engine 228. It should be noted that the components 202-228 shown in FIG. 2 are non-limiting examples provided for illustrative and explanation purposes, and other examples can include more, fewer, and/or different components than those shown in FIG. 2. For example, in some cases, the XR system 200 can include one or more other sensors (e.g., one or more inertial measurement units (IMUs), radars, light detection and ranging (LIDAR) sensors, radio detection and ranging (RADAR) sensors, sound detection and ranging (SODAR) sensors, sound navigation and ranging (SONAR) sensors. audio sensors, etc.), one or more display devices, one more other processing engines, one or more other hardware components, and/or one or more other software and/or hardware components that are not shown in FIG. 2. While various components of the XR system 200, such as the image sensor 202, may be referenced in the singular form herein, it should be understood that the XR system 200 may include multiple of any component discussed herein (e.g., multiple image sensors 202).

The XR system 200 can include or can be in communication with (wired or wirelessly) an input device 208. The input device 208 can include any suitable input device, such as a touchscreen, a pen or other pointer device, a keyboard, a mouse a button or key, a microphone for receiving voice commands, a gesture input device for receiving gesture commands, a video game controller, a steering wheel, a joystick, a set of buttons, a trackball, a remote control, any other input device 1045 discussed herein, or any combination thereof. In some cases, the image sensor 202 can capture images that can be processed for interpreting gesture commands.

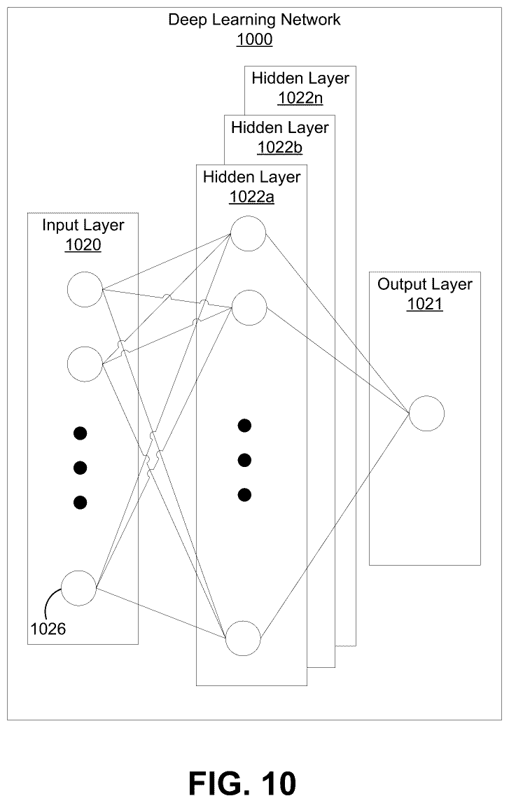

The XR system 200 can also communicate with one or more other electronic devices (wired or wirelessly). For example, communications engine 228 can be configured to manage connections and communicate with one or more electronic devices. In some cases, the communications engine 228 can correspond to the communications interface 1040 of FIG. 10.

In some implementations, the one or more image sensors 202, the accelerometer 204, the gyroscope 206, storage 207, compute components 210, XR engine 220, image processing engine 224, visual alignment engine 225, and rendering engine 226 can be part of the same computing device. For example, in some cases, the one or more image sensors 202, the accelerometer 204, the gyroscope 206, storage 207, compute components 210, XR engine 220, image processing engine 224, visual alignment engine 225, and rendering engine 226 can be integrated into an HMD, extended reality glasses, smartphone, laptop, tablet computer, gaming system, and/or any other computing device. However, in some implementations, the one or more image sensors 202, the accelerometer 204, the gyroscope 206, storage 207, compute components 210, XR engine 220, image processing engine 224, visual alignment engine, and rendering engine 226 can be part of two or more separate computing devices. For example, in some cases, some of the components 202-226 can be part of, or implemented by, one computing device and the remaining components can be part of, or implemented by, one or more other computing devices.

The storage 207 can be any storage device(s) for storing data. Moreover, the storage 207 can store data from any of the components of the XR system 200. For example, the storage 207 can store data from the image sensor 202 (e.g., image or video data), data from the accelerometer 204 (e.g., measurements), data from the gyroscope 206 (e.g., measurements), data from the compute components 210 (e.g., processing parameters, preferences, virtual content, rendering content, scene maps, tracking and localization data, object detection data, privacy data, XR application data, face recognition data, occlusion data, etc.), data from the XR engine 220, data from the image processing engine 224, data from the visual alignment engine (e.g., eye position) and/or data from the rendering engine 226 (e.g., output frames). In some examples, the storage 207 can include a buffer for storing frames for processing by the compute components 210.

The one or more compute components 210 can include a central processing unit (CPU) 212, a graphics processing unit (GPU) 214, a digital signal processor (DSP) 216, an image signal processor (ISP) 218, and/or other processor (e.g., a neural processing unit (NPU) implementing one or more trained neural networks). The compute components 210 can perform various operations such as image enhancement, computer vision, graphics rendering, extended reality operations (e.g., tracking, localization, pose estimation, mapping, content anchoring, content rendering, etc.), image and/or video processing, sensor processing, recognition (e.g., text recognition, facial recognition, object recognition, feature recognition, tracking or pattern recognition, scene recognition, occlusion detection, etc.), trained machine learning operations, filtering, and/or any of the various operations described herein. In some examples, the compute components 210 can implement (e.g., control, operate, etc.) the XR engine 220, the image processing engine 224, visual alignment engine 225, and the rendering engine 226. In other examples, the compute components 210 can also implement one or more other processing engines.

In some implementations, the image processing engine 224 may include or be included in an image capture and processing system 100, an image capture device 105A, an image processing device 105B, image processor 150, host processor 152, ISP 154, and/or any combination thereof.

The image sensor 202 can include any image and/or video sensors or capturing devices. In some examples, the image sensor 202 can be part of a multiple-camera assembly, such as a dual-camera assembly. The image sensor 202 can capture image and/or video content (e.g., raw image and/or video data), which can then be processed by the compute components 210, the XR engine 220, the image processing engine 224, visual alignment engine 225, and/or the rendering engine 226 as described herein. In some examples, the image sensors 202 may include an image capture and processing system 100, an image capture device 105A, an image processing device 105B, or a combination thereof.

In some examples, the image sensor 202 can capture image data and can generate images (also referred to as frames) based on the image data and/or can provide the image data or frames to the XR engine 220, the image processing engine 224, the visual alignment engine 225, and/or the rendering engine 226 for processing. An image or frame can include a video frame of a video sequence or a still image. An image or frame can include a pixel array representing a scene. For example, an image can be a red-green-blue (RGB) image having red, green, and blue color components per pixel; a luma, chroma-red, chroma-blue (YCbCr) image having a luma component and two chroma (color) components (chroma-red and chroma-blue) per pixel; or any other suitable type of color or monochrome image.

In some cases, the image sensor 202 (and/or other camera of the XR system 200) can be configured to also capture depth information. For example, in some implementations, the image sensor 202 (and/or other camera) can include an RGB-depth (RGB-D) camera. In some cases, the XR system 200 can include one or more depth sensors (not shown) that are separate from the image sensor 202 (and/or other camera) and that can capture depth information. For instance, such a depth sensor can obtain depth information independently from the image sensor 202. In some examples, a depth sensor can be physically installed in the same general location as the image sensor 202, but may operate at a different frequency or frame rate from the image sensor 202. In some examples, a depth sensor can take the form of a light source that can project a structured or textured light pattern, which may include one or more narrow bands of light, onto one or more objects in a scene. Depth information can then be obtained by exploiting geometrical distortions of the projected pattern caused by the surface shape of the object. In one example, depth information may be obtained from stereo sensors such as a combination of an infra-red structured light projector and an infra-red camera registered to a camera (e.g., an RGB camera).

The XR system 200 can also include other sensors in its one or more sensors. The one or more sensors can include one or more accelerometers (e.g., accelerometer 204), one or more gyroscopes (e.g., gyroscope 206), and/or other sensors. The one or more sensors can provide velocity, orientation, and/or other position-related information to the compute components 210. For example, the accelerometer 204 can detect acceleration by the XR system 200 and can generate acceleration measurements based on the detected acceleration. In some cases, the accelerometer 204 can provide one or more translational vectors (e.g., up/down, left/right, forward/back) that can be used for determining a position or pose of the XR system 200. The gyroscope 206 can detect and measure the orientation and angular velocity of the XR system 200. For example, the gyroscope 206 can be used to measure the pitch, roll, and yaw of the XR system 200. In some cases, the gyroscope 206 can provide one or more rotational vectors (e.g., pitch, yaw, roll). In some examples, the image sensor 202 and/or the XR engine 220 can use measurements obtained by the accelerometer 204 (e.g., one or more translational vectors) and/or the gyroscope 206 (e.g., one or more rotational vectors) to calculate the pose of the XR system 200. As previously noted, in other examples, the XR system 200 can also include other sensors, such as an inertial measurement unit (IMU), a magnetometer, a gaze and/or eye tracking sensor, a machine vision sensor, a smart scene sensor, a speech recognition sensor, an impact sensor, a shock sensor, a position sensor, a tilt sensor, etc.

As noted above, in some cases, the one or more sensors can include at least one IMU. An IMU is an electronic device that measures the specific force, angular rate, and/or the orientation of the XR system 200, using a combination of one or more accelerometers, one or more gyroscopes, and/or one or more magnetometers. In some examples, the one or more sensors can output measured information associated with the capture of an image captured by the image sensor 202 (and/or other camera of the XR system 200) and/or depth information obtained using one or more depth sensors of the XR system 200.

The output of one or more sensors (e.g., the accelerometer 204, the gyroscope 206, one or more IMUs, and/or other sensors) can be used by the XR engine 220 to determine a pose of the XR system 200 (also referred to as the head pose) and/or the pose of the image sensor 202 (or other camera of the XR system 200). In some cases, the pose of the XR system 200 and the pose of the image sensor 202 (or other camera) can be the same. The pose of image sensor 202 refers to the position and orientation of the image sensor 202 relative to a frame of reference (e.g., with respect to the scene 110). In some implementations, the camera pose can be determined for 6-Degrees Of Freedom (6DoF), which refers to three translational components (e.g., which can be given by X (horizontal), Y (vertical), and Z (depth) coordinates relative to a frame of reference, such as the image plane) and three angular components (e.g. roll, pitch, and yaw relative to the same frame of reference). In some implementations, the camera pose can be determined for 3-Degrees Of Freedom (3DoF), which refers to the three angular components (e.g. roll, pitch, and yaw).

In some cases, a device tracker (not shown) can use the measurements from the one or more sensors and image data from the image sensor 202 to track a pose (e.g., a 6DoF pose) of the XR system 200. For example, the device tracker can fuse visual data (e.g., using a visual tracking solution) from the image data with inertial data from the measurements to determine a position and motion of the XR system 200 relative to the physical world (e.g., the scene) and a map of the physical world. As described below, in some examples, when tracking the pose of the XR system 200, the device tracker can generate a three-dimensional (3D) map of the scene (e.g., the real world) and/or generate updates for a 3D map of the scene. The 3D map updates can include, for example and without limitation, new or updated features and/or feature or landmark points associated with the scene and/or the 3D map of the scene, localization updates identifying or updating a position of the XR system 200 within the scene and the 3D map of the scene, etc. The 3D map can provide a digital representation of a scene in the real/physical world. In some examples, the 3D map can anchor location-based objects and/or content to real-world coordinates and/or objects. The XR system 200 can use a mapped scene (e.g., a scene in the physical world represented by, and/or associated with, a 3D map) to merge the physical and virtual worlds and/or merge virtual content or objects with the physical environment.

In some aspects, the pose of image sensor 202 and/or the XR system 200 as a whole can be determined and/or tracked by the compute components 210 using a visual tracking solution based on images captured by the image sensor 202 (and/or other camera of the XR system 200). For instance, in some examples, the compute components 210 can perform tracking using computer vision-based tracking, model-based tracking, and/or simultaneous localization and mapping (SLAM) techniques. For instance, the compute components 210 can perform SLAM or can be in communication (wired or wireless) with a SLAM system (not shown), such as the SLAM system 300 of FIG. 3. SLAM refers to a class of techniques where a map of an environment (e.g., a map of an environment being modeled by XR system 200) is created while simultaneously tracking the pose of a camera (e.g., image sensor 202) and/or the XR system 200 relative to that map. The map can be referred to as a SLAM map, and can be three-dimensional (3D). The SLAM techniques can be performed using color or grayscale image data captured by the image sensor 202 (and/or other camera of the XR system 200), and can be used to generate estimates of 6DoF pose measurements of the image sensor 202 and/or the XR system 200. Such a SLAM technique configured to perform 6DoF tracking can be referred to as 6DoF SLAM. In some cases, the output of the one or more sensors (e.g., the accelerometer 204, the gyroscope 206, one or more IMUs, and/or other sensors) can be used to estimate, correct, and/or otherwise adjust the estimated pose.

In some cases, the 6DoF SLAM (e.g., 6DoF tracking) can associate features observed from certain input images from the image sensor 202 (and/or other camera) to the SLAM map. For example, 6DoF SLAM can use feature point associations from an input image to determine the pose (position and orientation) of the image sensor 202 and/or XR system 200 for the input image. 6DoF mapping can also be performed to update the SLAM map. In some cases, the SLAM map maintained using the 6DoF SLAM can contain 3D feature points triangulated from two or more images. For example, key frames can be selected from input images or a video stream to represent an observed scene. For every key frame, a respective 6DoF camera pose associated with the image can be determined. The pose of the image sensor 202 and/or the XR system 200 can be determined by projecting features from the 3D SLAM map into an image or video frame and updating the camera pose from verified 2D-3D correspondences.

In one illustrative example, the compute components 210 can extract feature points from certain input images (e.g., every input image, a subset of the input images, etc.) or from each key frame. A feature point (also referred to as a registration point) as used herein is a distinctive or identifiable part of an image, such as a part of a hand, an edge of a table, among others. Features extracted from a captured image can represent distinct feature points along three-dimensional space (e.g., coordinates on X, Y, and Z-axes), and every feature point can have an associated feature location. The feature points in key frames either match (are the same or correspond to) or fail to match the feature points of previously-captured input images or key frames. Feature detection can be used to detect the feature points. Feature detection can include an image processing operation used to examine one or more pixels of an image to determine whether a feature exists at a particular pixel. Feature detection can be used to process an entire captured image or certain portions of an image. For each image or key frame, once features have been detected, a local image patch around the feature can be extracted. Features may be extracted using any suitable technique, such as Scale Invariant Feature Transform (SIFT) (which localizes features and generates their descriptions), Learned Invariant Feature Transform (LIFT), Speed Up Robust Features (SURF), Gradient Location-Orientation histogram (GLOH), Oriented Fast and Rotated Brief (ORB), Binary Robust Invariant Scalable Keypoints (BRISK), Fast Retina Keypoint (FREAK), KAZE, Accelerated KAZE (AKAZE), Normalized Cross Correlation (NCC), descriptor matching, another suitable technique, or a combination thereof.

In some cases, the XR system 200 can also track the hand and/or fingers of the user to allow the user to interact with and/or control virtual content in a virtual environment. For example, the XR system 200 can track a pose and/or movement of the hand and/or fingertips of the user to identify or translate user interactions with the virtual environment. The user interactions can include, for example and without limitation, moving an item of virtual content, resizing the item of virtual content, selecting an input interface element in a virtual user interface (e.g., a virtual representation of a mobile phone, a virtual keyboard, and/or other virtual interface), providing an input through a virtual user interface, etc.

FIG. 3 is a block diagram illustrating an architecture of a SLAM system 300. In some examples, the SLAM system 300 can be, or can include, an extended reality (XR) system, such as the XR system 200 of FIG. 2. In some examples, the SLAM system 300 can be a wireless communication device, a mobile device or handset (e.g., a mobile telephone or so-called “smart phone” or other mobile device), a wearable device, a personal computer, a laptop computer, a server computer, a portable video game console, a portable media player, a camera device, a manned or unmanned ground vehicle, a manned or unmanned aerial vehicle, a manned or unmanned aquatic vehicle, a manned or unmanned underwater vehicle, a manned or unmanned vehicle, an autonomous vehicle, a vehicle, a computing system of a vehicle, a robot, another device, or any combination thereof.

The SLAM system 300 of FIG. 3 includes, or is coupled to, each of one or more sensors 305. The one or more sensors 305 can include one or more cameras 310. Each of the one or more cameras 310 may include an image capture device 105A, an image processing device 105B, an image capture and processing system 100, another type of camera, or a combination thereof. Each of the one or more cameras 310 may be responsive to light from a particular spectrum of light. The spectrum of light may be a subset of the electromagnetic (EM) spectrum. For example, each of the one or more cameras 310 may be a visible light (VL) camera responsive to a VL spectrum, an infrared (IR) camera responsive to an IR spectrum, an ultraviolet (UV) camera responsive to a UV spectrum, a camera responsive to light from another spectrum of light from another portion of the electromagnetic spectrum, or a some combination thereof.

The one or more sensors 305 can include one or more other types of sensors other than cameras 310, such as one or more of each of: accelerometers, gyroscopes, magnetometers, inertial measurement units (IMUs), altimeters, barometers, thermometers, radio detection and ranging (RADAR) sensors, light detection and ranging (LIDAR) sensors, sound navigation and ranging (SONAR) sensors, sound detection and ranging (SODAR) sensors, global navigation satellite system (GNSS) receivers, global positioning system (GPS) receivers, BeiDou navigation satellite system (BDS) receivers, Galileo receivers, Globalnaya Navigazionnaya Sputnikovaya Sistema (GLONASS) receivers, Navigation Indian Constellation (NavIC) receivers, Quasi-Zenith Satellite System (QZSS) receivers, Wi-Fi positioning system (WPS) receivers, cellular network positioning system receivers, Bluetooth® beacon positioning receivers, short-range wireless beacon positioning receivers, personal area network (PAN) positioning receivers, wide area network (WAN) positioning receivers, wireless local area network (WLAN) positioning receivers, other types of positioning receivers, other types of sensors discussed herein, or combinations thereof. In some examples, the one or more sensors 305 can include any combination of sensors of the XR system 200 of FIG. 2.

The SLAM system 300 of FIG. 3 includes a visual-inertial odometry (VIO) tracker 315. The term visual-inertial odometry may also be referred to herein as visual odometry. The VIO tracker 315 receives sensor data 365 from the one or more sensors 305. For instance, the sensor data 365 can include one or more images captured by the one or more cameras 310. The sensor data 365 can include other types of sensor data from the one or more sensors 305, such as data from any of the types of sensors 305 listed herein. For instance, the sensor data 365 can include inertial measurement unit (IMU) data from one or more IMUs of the one or more sensors 305.

Upon receipt of the sensor data 365 from the one or more sensors 305, the VIO tracker 315 performs feature detection, extraction, and/or tracking using a feature tracking engine 320 of the VIO tracker 315. For instance, where the sensor data 365 includes one or more images captured by the one or more cameras 310 of the SLAM system 300, the VIO tracker 315 can identify, detect, and/or extract features in each image. Features may include visually distinctive points in an image, such as portions of the image depicting edges and/or corners. The VIO tracker 315 can receive sensor data 365 periodically and/or continually from the one or more sensors 305, for instance by continuing to receive more images from the one or more cameras 310 as the one or more cameras 310 capture a video, where the images are video frames of the video. The VIO tracker 315 can generate descriptors for the features. Feature descriptors can be generated at least in part by generating a description of the feature as depicted in a local image patch extracted around the feature. In some examples, a feature descriptor can describe a feature as a collection of one or more feature vectors. The VIO tracker 315, in some cases with the mapping engine 330 and/or the relocalization engine 355, can associate the plurality of features with a map of the environment based on such feature descriptors. The feature tracking engine 320 of the VIO tracker 315 can perform feature tracking by recognizing features in each image that the VIO tracker 315 already previously recognized in one or more previous images, in some cases based on identifying features with matching feature descriptors in different images. The feature tracking engine 320 can track changes in one or more positions at which the feature is depicted in each of the different images. For example, the feature extraction engine can detect a particular corner of a room depicted in a left side of a first image captured by a first camera of the cameras 310. The feature extraction engine can detect the same feature (e.g., the same particular corner of the same room) depicted in a right side of a second image captured by the first camera. The feature tracking engine 320 can recognize that the features detected in the first image and the second image are two depictions of the same feature (e.g., the same particular corner of the same room), and that the feature appears in two different positions in the two images. The VIO tracker 315 can determine, based on the same feature appearing on the left side of the first image and on the right side of the second image that the first camera has moved, for example if the feature (e.g., the particular corner of the room) depicts a static portion of the environment.)

The VIO tracker 315 can include a sensor integration engine 325. The sensor integration engine 325 can use sensor data from other types of sensors 305 (other than the cameras 310) to determine information that can be used by the feature tracking engine 320 when performing the feature tracking. For example, the sensor integration engine 325 can receive IMU data (e.g., which can be included as part of the sensor data 365) from an IMU of the one or more sensors 305. The sensor integration engine 325 can determine, based on the IMU data in the sensor data 365, that the SLAM system 300 has rotated 15 degrees in a clockwise direction from acquisition or capture of a first image to acquisition or capture of the second image by a first camera of the cameras 310. Based on this determination, the sensor integration engine 325 can identify that a feature depicted at a first position in the first image is expected to appear at a second position in the second image, and that the second position is expected to be located to the left of the first position by a predetermined distance (e.g., a predetermined number of pixels, inches, centimeters, millimeters, or another distance metric). The feature tracking engine 320 can take this expectation into consideration in tracking features between the first image and the second image.

Based on the feature tracking by the feature tracking engine 320 and/or the sensor integration by the sensor integration engine 325, the VIO tracker 315 can determine a 3D feature positions 372 of a particular feature. The 3D feature positions 372 can include one or more 3D feature positions and can also be referred to as 3D feature points. The 3D feature positions 372 can be a set of coordinates along three different axes that are perpendicular to one another, such as an X coordinate along an X axis (e.g., in a horizontal direction), a Y coordinate along a Y axis (e.g., in a vertical direction) that is perpendicular to the X axis, and a Z coordinate along a Z axis (e.g., in a depth direction) that is perpendicular to both the X axis and the Y axis. The VIO tracker 315 can also determine one or more keyframes 370 (referred to hereinafter as keyframes 370) corresponding to the particular feature. In some examples, a keyframe (from the one or more keyframes 370) corresponding to a particular feature may be an image in which the particular feature is clearly depicted. In some examples, a keyframe corresponding to a particular feature may be an image that reduces uncertainty in the 3D feature positions 372 of the particular feature when considered by the feature tracking engine 320 and/or the sensor integration engine 325 for determination of the 3D feature positions 372. In some examples, a keyframe corresponding to a particular feature also includes data about the pose 385 of the SLAM system 300 and/or the camera(s) 310 during capture of the keyframe. In some examples, the VIO tracker 315 can send 3D feature positions 372 and/or keyframes 370 corresponding to one or more features to the mapping engine 330. In some examples, the VIO tracker 315 can receive map slices 375 from the mapping engine 330. The VIO tracker 315 can extract feature information within the map slices 375 for feature tracking using the feature tracking engine 320.

Based on the feature tracking by the feature tracking engine 320 and/or the sensor integration by the sensor integration engine 325, the VIO tracker 315 can determine a pose 385 of the SLAM system 300 and/or of the cameras 310 during capture of each of the images in the sensor data 365. The pose 385 can include a location of the SLAM system 300 and/or of the cameras 310 in 3D space, such as a set of coordinates along three different axes that are perpendicular to one another (e.g., an X coordinate, a Y coordinate, and a Z coordinate). The pose 385 can include an orientation of the SLAM system 300 and/or of the cameras 310 in 3D space, such as pitch, roll, yaw, or some combination thereof. In some examples, the VIO tracker 315 can send the pose 385 to the relocalization engine 355. In some examples, the VIO tracker 315 can receive the pose 385 from the relocalization engine 355.

The SLAM system 300 also includes a mapping engine 330. The mapping engine 330 generates a 3D map of the environment based on the 3D feature positions 372 and/or the keyframes 370 received from the VIO tracker 315. The mapping engine 330 can include a map densification engine 335, a keyframe remover 340, a bundle adjuster 345, and/or a loop closure detector 350. The map densification engine 335 can perform map densification, in some examples, increase the quantity and/or density of 3D coordinates describing the map geometry. The keyframe remover 340 can remove keyframes, and/or in some cases add keyframes. In some examples, the keyframe remover 340 can remove keyframes 370 corresponding to a region of the map that is to be updated and/or whose corresponding confidence values are low. The bundle adjuster 345 can, in some examples, refine the 3D coordinates describing the scene geometry, parameters of relative motion, and/or optical characteristics of the image sensor used to generate the frames, according to an optimality criterion involving the corresponding image projections of all points. The loop closure detector 350 can recognize when the SLAM system 300 has returned to a previously mapped region, and can use such information to update a map slice and/or reduce the uncertainty in certain 3D feature points or other points in the map geometry. The mapping engine 330 can output map slices 375 to the VIO tracker 315. The map slices 375 can represent 3D portions or subsets of the map. The map slices 375 can include map slices 375 that represent new, previously-unmapped areas of the map. The map slices 375 can include map slices 375 that represent updates (or modifications or revisions) to previously-mapped areas of the map. The mapping engine 330 can output map information 380 to the relocalization engine 355. The map information 380 can include at least a portion of the map generated by the mapping engine 330. The map information 380 can include one or more 3D points making up the geometry of the map, such as one or more 3D feature positions 372. The map information 380 can include one or more keyframes 370 corresponding to certain features and certain 3D feature positions 372.

The SLAM system 300 also includes a relocalization engine 355. The relocalization engine 355 can perform relocalization, for instance when the VIO tracker 315 fail to recognize more than a threshold number of features in an image, and/or the VIO tracker 315 loses track of the pose 385 of the SLAM system 300 within the map generated by the mapping engine 330. The relocalization engine 355 can perform relocalization by performing extraction and matching using an extraction and matching engine 360. For instance, the extraction and matching engine 360 can extract features from an image captured by the cameras 310 of the SLAM system 300 while the SLAM system 300 is at a current pose 385, and can match the extracted features to features depicted in different keyframes 370, identified by 3D feature positions 372, and/or identified in the map information 380. By matching these extracted features to the previously-identified features, the relocalization engine 355 can identify that the pose 385 of the SLAM system 300 is a pose 385 at which the previously-identified features are visible to the cameras 310 of the SLAM system 300, and is therefore similar to one or more previous poses 385 at which the previously-identified features were visible to the cameras 310. In some cases, the relocalization engine 355 can perform relocalization based on wide baseline mapping, or a distance between a current camera position and camera position at which feature was originally captured. The relocalization engine 355 can receive information for the pose 385 from the VIO tracker 315, for instance regarding one or more recent poses of the SLAM system 300 and/or cameras 310, which the relocalization engine 355 can base its relocalization determination on. Once the relocalization engine 355 relocates the SLAM system 300 and/or cameras 310 and thus determines the pose 385, the relocalization engine 355 can output the pose 385 to the VIO tracker 315.

In some examples, the VIO tracker 315 can modify the image in the sensor data 365 before performing feature detection, extraction, and/or tracking on the modified image. For example, the VIO tracker 315 can rescale and/or resample the image. In some examples, rescaling and/or resampling the image can include downscaling, downsampling, subscaling, and/or subsampling the image one or more times. In some examples, the VIO tracker 315 modifying the image can include converting the image from color to greyscale, or from color to black and white, for instance by desaturating color in the image, stripping out certain color channel(s), decreasing color depth in the image, replacing colors in the image, or a combination thereof. In some examples, the VIO tracker 315 modifying the image can include the VIO tracker 315 masking certain regions of the image. Dynamic objects can include objects that can have a changed appearance between one image and another. For example, dynamic objects can be objects that move within the environment, such as people, vehicles, or animals. A dynamic object can be an object that has a changing appearance at different times, such as a display screen that may display different things at different times. A dynamic object can be an object that has a changing appearance based on the pose of the camera(s) 310, such as a reflective surface, a prism, or a specular surface that reflects, refracts, and/or scatters light in different ways depending on the position of the camera(s) 310 relative to the dynamic object. The VIO tracker 315 can detect the dynamic objects using facial detection, facial recognition, facial tracking, object detection, object recognition, object tracking, or a combination thereof. The VIO tracker 315 can detect the dynamic objects using one or more artificial intelligence algorithms, one or more trained machine learning models, one or more trained neural networks, or a combination thereof. The VIO tracker 315 can mask one or more dynamic objects in the image by overlaying a mask over an area of the image that includes depiction(s) of the one or more dynamic objects. The mask can be an opaque color, such as black. The area can be a bounding box having a rectangular or other polygonal shape. The area can be determined on a pixel-by-pixel basis.

Returning to FIG. 2, as noted above, XR system 200, including the compute components 210, the XR engine 220, the visual alignment engine 225, the rendering engine 226 of the and/or any combination thereof, can position and/or anchor virtual content in a specific location(s) on the 3D map of the environment (e.g., a 3D map generated by XR system 200 of FIG. 2 and/or SLAM system 300 of FIG. 3), and render the virtual content on the display 209 such that the virtual content appears to be at a location in the environment corresponding to the specific location on the map of the scene where the virtual content is positioned and/or anchored.

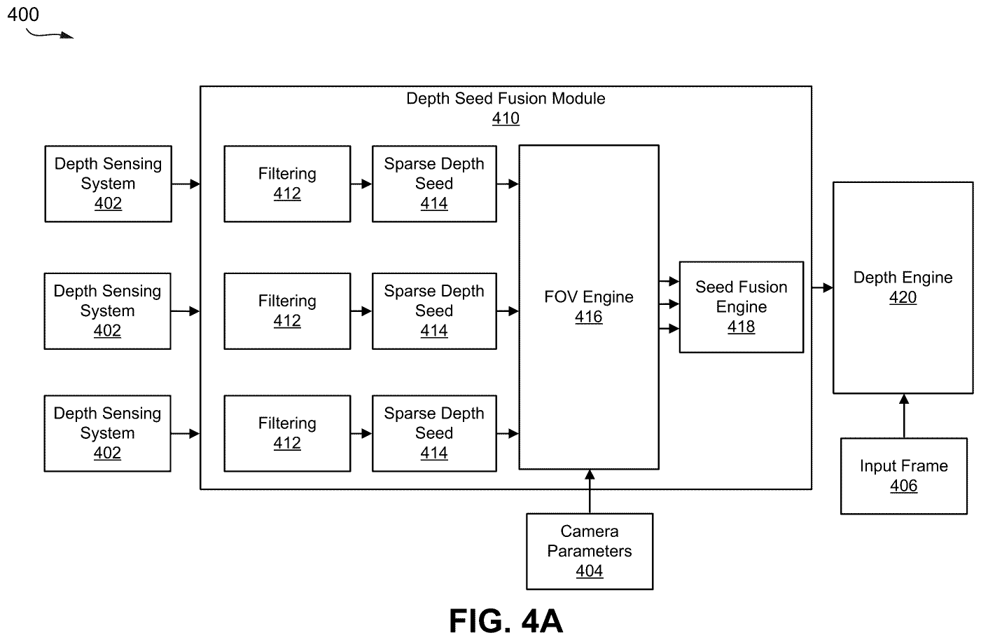

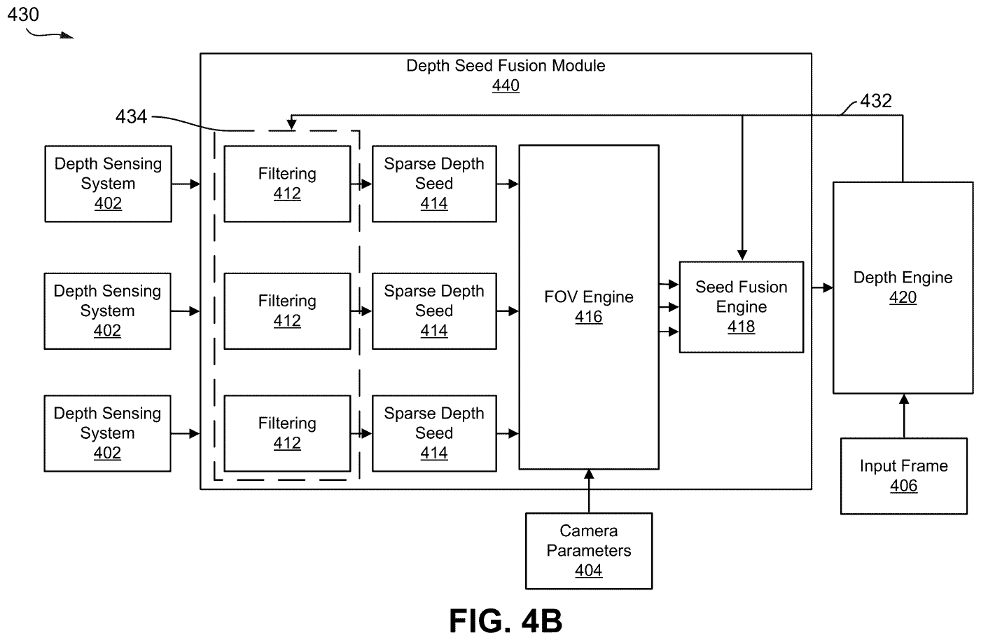

FIG. 4A is a block diagram illustrating an example architecture of a depth seed fusion system 400 including a depth seed fusion module 410. The depth seed fusion module 410 includes various components that are used to obtain depth information from multiple depth data sources (e.g., depth sensing systems 402) and generate a fused depth seed based on the multiple depth data sources. In some cases, the fused depth seed generated by the depth seed fusion module 410 can be provided as an additional input to a depth engine 420 during generation of a dense depth map based on one or more input image frames. As illustrated, the depth seed fusion module 410 includes filtering modules 412, a FOV engine 416, and a seed fusion engine 418.

In some implementations, the depth seed fusion module 410 can obtain depth data from depth sensing systems 402. In some examples, the depth sensing systems 402 can operate to capture and/or generate depth data in parallel to one another. In some cases, one or more of the depth sensing systems 402 can be operated asynchronously. In some implementations, depth data from different depth sensing systems of the depth sensing systems 402 may be associated with different FOVs. In some cases, depth data from each depth sensing system of the depth sensing systems 402 can include a depth map of a scene. In some examples, the depth data from a depth sensing system of the depth sensing systems 402 can include a sparse depth map. In some aspects, the depth data from a depth sensing system of the depth sensing systems 402 can include a dense depth map. In some implementations, depth data from a depth sensing system of the depth sensing systems 402 can include confidence data. For example, the confidence data can include confidence values associated with depth values in a corresponding depth map. In some implementations, the depth data from a depth sensing system of the depth sensing systems 402 can include a three-dimensional (3D) point cloud. As illustrated in FIG. 4A, the depth seed fusion module 410 can incorporate a separate depth data processing pipeline for each depth sensing systems 402 (e.g., each depth data source). For example, a depth processing pipeline associated with a depth sensing system of the depth sensing systems 402 can include a filtering module 412 and the FOV engine 416. While the depth seed fusion system 400 of FIG. 4A illustrates a depth seed fusion module 410 that obtains depth data from three depth sensing systems 402, it should be understood that a depth seed fusion module 410 that obtains data from N depth sensing systems 402, where Nis an integer and N≥2 can be used without departing from the scope of the present disclosure.

In some cases, each filtering module 412 can be configured to filter the depth data associated with a particular depth sensing system of the depth sensing systems 402. For example, a first filtering module 412 may be configured to receive a depth map (e.g., a sparse depth map or a dense depth map) and corresponding confidence values. In some cases, a second filtering module 412 may be configured to receive a depth map only. In some examples, a filtering module 412 may be configured to determine whether depth data from a corresponding depth data source (e.g., a depth sensing system of depth sensing systems 402) satisfies one or more filtering conditions. In some aspects, a filtering module 412 may remove depth data values from the depth data provided by a corresponding depth data source (e.g., depth sensing systems 402) that do not satisfy the one or more filtering conditions. In some examples, a filtering module 412 may modify depth data values from the depth data provided by a corresponding depth data source (e.g., a depth sensing system of depth sensing systems 402) based on the one or more filtering conditions.

In some cases, the one or more filtering conditions can be used to remove and/or modify depth values for which the corresponding depth sensing system of the depth sensing systems 402 is known to be inaccurate and/or low confidence. In one illustrative example, one or more filtering conditions for a filtering module 412 can be based on a specific sensor profile associated with a sensor included in a corresponding depth sensing system of the depth sensing systems 402. In another illustrative example, one or more filtering conditions for a filtering module 412 can be based on a confidence mask associated with a sensor included in a corresponding depth sensing system of the depth sensing systems 402. In some cases, each filtering module 412 can output a sparse depth seed 414.

As noted above, depth data captured by each depth sensing system of the depth sensing systems 402 can be associated with a particular FOV. In some cases, two or more depth sensing systems of the depth sensing systems 402 may share a common FOV. However, in some cases, each depth sensing system of the depth sensing systems 402 may provide depth data associated with a different FOV from every other depth sensing system of the depth sensing systems 402. Accordingly, the sparse depth seeds 414 may represent up to N different FOVs. In some implementations, the FOV engine 416 can be used to align the different FOVs represented by the sparse depth seeds 414 to a target FOV. In one illustrative example, the target FOV can correspond to the FOV of an input frame 406 provided to depth engine 420. In some cases, by aligning the sparse depth seeds 414 to the target FOV, the depth seed fusion module 410 can generate a depth seed for the depth engine 420 that matches with the FOV of the input frame 406.

In some cases, a sparse depth seed 414 can include two-dimensional (2D) array of depth values associated with a 2D FOV that is different from the target FOV. In some cases, the depth values associated with the 2D FOV can be projected into a 3D coordinate system. In some examples, the 3D coordinate system may be referred to as a 3D object space. In some cases, the 3D coordinate system can include an origin point and orthogonal axes (e.g., X-axis, Y-axis, Z-axis). In some examples, the FOV engine 416 can project the depth values associated with the 2D FOV into the 3D object space. In some cases, the FOV engine 416 may utilize a pose of the depth sensing system of the depth sensing systems 402 that provided the depth data used to generate the sparse depth seed 414 to project the depth values associated with the 2D FOV into the 3D object space. In some implementations, the FOV engine 416 may utilize sensor parameters of the depth sensing system of the depth sensing systems 402 that provided the depth data used to generate the sparse depth seed 414 to project the depth values associated with the 2D FOV into the 3D object space. For example, where the depth sensing system utilizes a camera, the FOV engine 416 may utilize intrinsic camera parameters of the camera to project the depth values associated with the 2D FOV into the 3D object space.

In some cases, a sparse depth seed 414 can include a 3D point cloud. In some cases, the 3D point cloud may include 3D points in a 3D coordinate system that is different from the 3D object space. In some cases, the FOV engine 416 can translate the 3D vertices of the 3D point cloud into the 3D object space. In some cases, the FOV engine 416 can include scaling, rotation, and/or translation of the 3D vertices of the 3D point cloud. In some cases, the FOV engine 416 may utilize a pose of the depth sensing system that provided the depth data used to generate the sparse depth seed 414 to translate the depth values associated with the 3D point cloud into the 3D object space. In some implementations, the FOV engine 416 may utilize sensor parameters of the depth sensing system that provided the depth data used to generate the sparse depth seed 414 to project the depth values associated with the 3D point cloud into the 3D object space. For example, where the depth sensing system utilizes a camera, the FOV engine 416 may utilize intrinsic camera parameters of the camera to translate the depth values associated with the 3D point cloud into the 3D object space.

In some cases, after adjusting a sparse depth seed 414 into a 3D representation of the sparse depth seed in the 3D object space, the FOV engine 416 can project (or re-project) the 3D representation of the sparse depth seed into the target FOV. For example, the 3D representation of the sparse depth speed in the 3D object space can be projected using various projection techniques (e.g., perspective projection, weak perspective projection, and/or any other projection techniques). In some cases, a 3D vertex X_{o,i} in the 3D object space can be projected from the location of a target camera and the projection can be represented mathematically as illustrated in Equation (1) below:

$${\vec{x}}_{o a , i} = {P}_{{A}_{a}} ( {𝕋}_{o}^{a} ( {X}_{o , i} ) ) \qquad ( 1 )$$

Where P_{A}_{ₐ} is a projection matrix from the assumed eye position, [symbol] ₒ^{a} represents a pose of the target camera relative to the 3D object space, and \vec{x}_{oa,i} is a vector representing the projected 2D pixel position (e.g., at the image plane of the target camera) of a particular 3D vertex X_{o,i} with index i. In some cases, the FOV engine 416 can obtain camera parameters 404 associated with the target camera. In some cases, the projection matrix P_{A}_{ₐ} can incorporate the camera parameters 404. In some aspects, the FOV engine 416 can output an FOV adjusted sparse depth seed for each sparse depth seed 414.

In some implementations, seed fusion engine 418 can fuse the FOV adjusted sparse depth seeds for each sparse depth seed 414 and generate a fused sparse depth seed. In some examples, the fused sparse depth seed can include an array of depth values where each depth value in the array of depth values corresponds to a pixel in the input frame 406 to the depth engine 420. In some cases, the fused sparse depth seed and the input frame 406 can have the same shape and/or resolution (e.g., number of rows and number of columns). In one illustrative example, the array of depth values can include a two-dimensional where a depth value at a particular array location (e.g., a particular row and column) included in the array of depth values corresponds to a depth measurement for a corresponding pixel location (e.g., the particular row and column) in the input frame 406. In some cases, the fused sparse depth seed can be provided as the additional input to the depth engine 420.

In some cases, where only a single FOV adjusted sparse depth seed of the FOV adjusted sparse depth seeds provided by the FOV engine 416 includes a depth value corresponding to a particular pixel location of the input frame 406, the seed fusion engine 418 can utilize the depth value from the first sparse depth seed as the depth value for the fused sparse depth seed.

In some examples, where multiple FOV adjusted sparse depth seeds of the FOV adjusted sparse depth seeds provided by the FOV engine 416 include a depth value corresponding to a particular pixel location of the input frame 406, the seed fusion engine 418 can select a depth value from one of the multiple FOV adjusted sparse depth seeds. In some cases, the seed fusion engine 418 may select a depth value based on quality of the depth value. In some cases, the seed fusion engine 418 can select between the depth values from multiple FOV adjusted sparse depth seeds based on a comparison of confidence values for the depth values. In some implementations, the seed fusion engine 418 can select between the depth values from multiple FOV adjusted sparse depth seeds based on a preference between depth data sources (e.g., depth sensing systems 402) at the particular pixel location. In some aspects, the seed fusion engine 418 can select between the depth values based on quality priors stored in a look-up table.

As noted above, in some cases, the depth engine 420 can be implemented as a machine learning depth model. Example architectures for the machine learning depth model may include, without limitation, a CNN, Transformer, GAN, variational autoencoder (VAE), a diffusion module, RNN, and/or any combination thereof.

In one illustrative example, the depth engine 420 can be implemented using a CNN. For example, the depth engine 420 may be implemented using a stand-alone feed-forward CNN. During training, the depth engine 420 can learn to generate a dense depth seed based on an input frame and an input sparse depth seed. In one illustrative example, the training data used to train the neural network of the depth engine 420 can include frames, sparse depth seeds, and dense depth seeds. In some cases, the dense depth seeds can be used as the ground truth data for a supervised learning process. A forward pass can include passing an input frame and an input spare depth seed through the neural network. Weights of the neural network may be initially randomized before the neural network is trained. For a first training iteration for the neural network system, the output may include values that do not give preference to any particular output, as the weights have not yet been calibrated. For example, the output can include a data representation (e.g., a vector, an array, etc.) with values representing depth values for each pixel of an input frame. After the first training iteration using the initial weights, the depth values output by the machine learning model will likely be different from the depth values provided in the ground truth dense depth map for that frame.

A loss function can be used to analyze error in the output. In the example, a Cross-Entropy loss can be used. Other loss functions can be used in some cases. One example of another loss function includes a mean squared error (MSE), defined as

$${E}_{total} = \sum \frac{1}{2} {( target - output )}^{2} .$$

The MSE calculates the sum of one-half times the actual answer minus the predicted (output) answer squared. The loss (or error) may be high for the first or initial training input frames, since the actual output values (depth values estimated by the neural network for those input frames and input sparse depth seeds) may be much different than the predicted output (the features provided by ground truth dense depth seeds for those frames). A goal of training is to minimize the amount of loss for the predicted output.

In some implementations, the neural network can perform a backward pass by determining which inputs (weights) most contributed to the loss of the neural network and can adjust the weights so the loss decreases and is eventually minimized. A derivative of the loss with respect to the weights (denoted as dL/dW, where W are the weights at a particular layer) can be computed to determine the weights that most contributed to the loss of the neural network. For example, the weights can be updated so they change in the opposite direction of the gradient. The weight update can be denoted as

$$w = {w}_{i} - η \frac{d L}{d W} ,$$

where w denotes a weight, wᵢ denotes the initial weight, and η denotes a learning rate. The learning rate can be set to any suitable value, with a high learning rate indicating larger weight updates and a lower value indicating smaller weight updates. The neural network of the depth engine 420 can continue to be trained in such a manner until a desired output is achieved.

In another illustrative example, the depth engine 420 can be implemented using a GAN. As noted above, a GAN is a form of generative neural network that can learn patterns in input data so that the neural network model can generate new synthetic outputs that reasonably could have been from the original dataset. A GAN can include two neural networks that operate together. One of the neural networks (referred to as a generative neural network or generator denoted as G(z)) generates a synthesized output, and the other neural network (referred to as a discriminative neural network or discriminator denoted as D(X)) evaluates the output for authenticity (whether the output is from an original dataset, such as the training dataset, or is generated by the generator). The training input for the generator can include input frames and sparse depth maps. The training input for the discriminator can include dense depth maps. The generator is trained to try and fool the discriminator into determining a synthesized dense depth map generated by the generator is a real dense depth map from the dataset. The training process continues and the generator becomes better at generating the synthetic dense depth maps that look like real dense depth maps. The discriminator continues to find flaws in the synthesized dense depth maps, and the generator figures out what the discriminator is looking at to determine the flaws in the dense depth maps. Once the network is trained, the generator is able to produce dense depth maps that the discriminator is unable to distinguish from the real dense depth maps.

As illustrated in FIG. 4A, the depth engine 420 may perform depth estimation based on an input frame 406 with the target FOV obtained from a depth sensing systems 402 associated with the target FOV and a corresponding fused sparse depth seed. In some cases, the input frame 406 can be generated from a pair of stereoscopic images combined into an input frame 406 with the target FOV and a corresponding fused sparse depth seed. In one illustrative example, the input frame 406 with the target FOV can be an undistorted image formed by combining a pair of stereoscopic images.

FIG. 4B is a block diagram illustrating an example architecture of a depth seed fusion system 430 including an adjustable depth seed fusion module 440 with capability for adjusting filtering by filtering modules 412 and/or seed fusion by seed fusion engine 418. In the illustrated example of FIG. 4B, the adjustable depth seed fusion module 440 is configured to receive adjustments 432 from the depth engine 420 that can be used to adjust the filtering configuration 434 (e.g., filtering conditions of one or more filtering modules 412). In some implementations, the adjustments 432 may also be used to adjust operation of the seed fusion engine 418. For example, the adjustments 432 may include different weightings to be applied to depth values from each of the FOV adjusted sparse depth seeds input into the seed fusion engine 418. In some cases, the seed fusion engine 418 can be configured to select between depth values in different FOV adjusted sparse depth seeds based on quality priors (e.g., a look-up table) and/or confidence-based depth map filtering. In some cases, the operation of the seed fusion engine 418 can be varied based on the requirements of a particular depth engine 420 coupled to the adjustable depth seed fusion module 440. Accordingly, the adjustable depth seed fusion module 440 can be utilized for generating fused sparse depth seeds for depth engines 420 with different requirements.

In some examples, the XR system 200 of FIG. 2 can include the depth seed fusion module 410 of FIG. 4A, the adjustable depth seed fusion module 440 of FIG. 4B, the depth sensing systems 402, the depth engine 420, or a combination thereof. In some examples, the simultaneous SLAM system 300 of FIG. 3 can include the depth seed fusion module 410 of FIG. 4A, the adjustable depth seed fusion module 440 of FIG. 4B, the depth sensing systems 402, the depth engine 420, or a combination thereof.

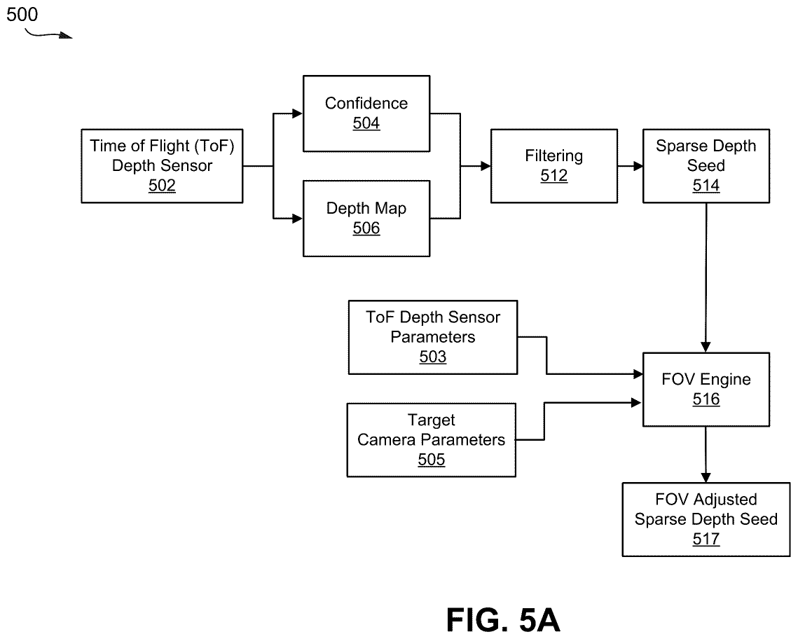

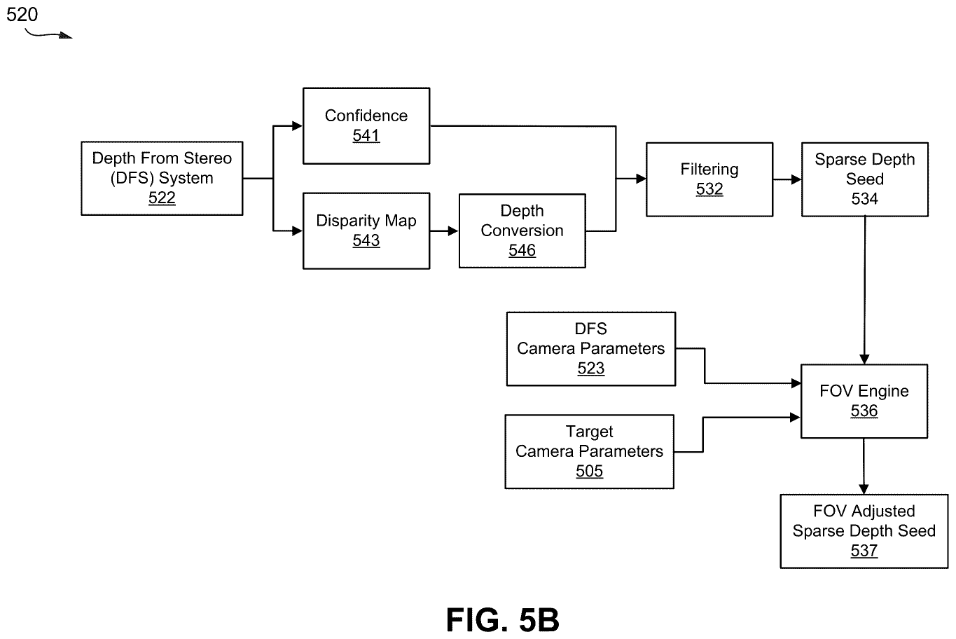

FIG. 5A and FIG. 5B are block diagrams illustrating example generation of FOV adjusted sparse depth seeds for different type of depth sensing systems. It should be understood that the systems and techniques described herein are not limited to any particular depth sensing system and other depth sensing systems can be used without departing from the scope of the present disclosure.

FIG. 5A illustrates a block diagram 500 of generation of a FOV adjusted sparse depth seed 517 based on depth data from a ToF depth sensor 502. As illustrated in FIG. 5A, the ToF depth sensor 502 can produce confidence values 504 corresponding to depth values in a depth map 506. In one illustrative example, the ToF depth sensor 502 can correspond to a depth sensing system 402 of FIG. 4A and FIG. 4B. In some examples, the confidence values 504, and depth map 506 correspond to the depth data output from a depth sensing system of the depth sensing systems 402 of FIG. 4A to the depth seed fusion module 410 of FIG. 4A and/or can correspond to the output from a depth sensing system of the depth sensing systems 402 of FIG. 4B to the adjustable depth seed fusion module 440 of FIG. 4B. In the illustrated example of FIG. 5A, the filtering module 512 can be similar to and perform similar functions to the filtering module 412 of FIG. 4A and FIG. 4B. Similarly, the sparse depth seed 514 of FIG. 5A can be similar to and perform similar functions to the sparse depth seed 414 of FIG. 4A and FIG. 4B. In addition, the FOV engine 516 of FIG. 5A can be similar to and perform similar functions to the FOV engine 416 of FIG. 4A and FIG. 4B. As illustrated in FIG. 5A, the FOV engine 516 can obtain ToF depth sensor parameters 503 for projection from an FOV of the depth data from the ToF depth sensor 502 into a 3D representation of the sparse depth seed 514 in a 3D object space. In some cases, the FOV engine 516 can obtain target camera parameters 505 for re-projection of the 3D representation of the sparse depth seed 514 in the 3D object space into a FOV adjusted sparse depth seed 517.

FIG. 5B illustrates a block diagram 520 of generation of a FOV adjusted sparse depth seed 537 based on depth data from a DFS system 522. As illustrated in FIG. 5B, the DFS system 522 can produce confidence values 504 corresponding to depth values in a depth map 506. In one illustrative example, the DFS system 522 can correspond to a depth sensing system 402 of FIG. 4A and FIG. 4B. In the illustrated example of FIG. 5B, the filtering module 532 can be similar to and perform similar functions to the filtering module 412 of FIG. 4A and FIG. 4B. Similarly, the sparse depth seed 534 of FIG. 5B can be similar to and perform similar functions to the sparse depth seed 414 of FIG. 4A and FIG. 4B. In addition, the FOV engine 536 of FIG. 5B can be similar to and perform similar functions to the FOV engine 416 of FIG. 4A and FIG. 4B.

As illustrated in FIG. 5B, the DFS system 522 can output confidence values 541 and a disparity map 543. A disparity map generated for a stereo image pair can be used to generate depth information of the scene depicted in the stereo image pair. In some examples, the disparity map 543 output by the DFS system 522 can be converted into a depth map by a depth conversion module 546 to produce a depth map. For example, depth information (e.g., a depth estimate) can be determined using the disparity map and camera intrinsic information corresponding to the left and right cameras used to capture the left and right images (respectively), of the stereo image pair. Camera intrinsic information can include the distance between the image sensor or imaging plane of the left camera and the image sensor or imaging plane of the right camera (e.g., the baseline distance between the left and right cameras). The camera intrinsic information can additionally include a focal length associated with the left camera/left image and a focal length associated with the right camera/right image. Given the baseline distance and respective focal lengths of the left and right cameras, a one-to-one mapping between disparity information and depth information can be calculated. For instance, a depth map can be generated based on calculating, for each pixel location of the disparity map, a corresponding depth value given by: depth=(baseline*focal length)/disparity.

In some examples, the confidence values from the confidence values 541 and the depth map from the depth conversion module 546 can correspond to the depth data output from a depth sensing system of the depth sensing systems 402 of FIG. 4A to the depth seed fusion module 410 of FIG. 4A and/or can correspond to the output from a depth sensing system of the depth sensing systems 402 of FIG. 4B to the adjustable depth seed fusion module 440 of FIG. 4B. As illustrated in FIG. 5B, the FOV engine 536 can obtain DFS camera parameters 523 for projection from an FOV of the depth data from the DFS system 522 into a 3D representation of the sparse depth seed 534 in a 3D object space. In some cases, the FOV engine 536 can obtain target camera parameters 505 for re-projection of the 3D representation of the sparse depth seed 534 in the 3D object space into a FOV adjusted sparse depth seed 537.

As should be understood from the description above, the systems and techniques described herein can generate a fused sparse depth seed with a target FOV based on depth data obtained from multiple depth data sources (e.g., depth sensing systems 402 of FIG. 4A and FIG. 4B) that have FOVs that may or may not match the target FOV. The systems and techniques can filter the depth data from each depth source to generate sparse depth seeds. In addition, the systems and techniques can adjust the FOV of any of the sparse depth seeds that do not match the target FOV to generate FOV adjusted sparse depth seeds with the target FOV. In some cases, the systems and techniques can generate the fused sparse depth seed with the target FOV based on the FOV adjusted sparse depth seeds. In some cases, an input frame from one or more cameras and the fused sparse depth seed can be provided to a depth estimation model that generates a dense depth map. In some implementations, the depth estimation model can be implemented by a machine learning model. In some cases, the fused sparse depth seed with the target FOV based on multiple depth data sources can provide a stable, high-confidence, and/or sufficiently dense sparse depth seed to improve the dense depth map output by the depth estimation model.

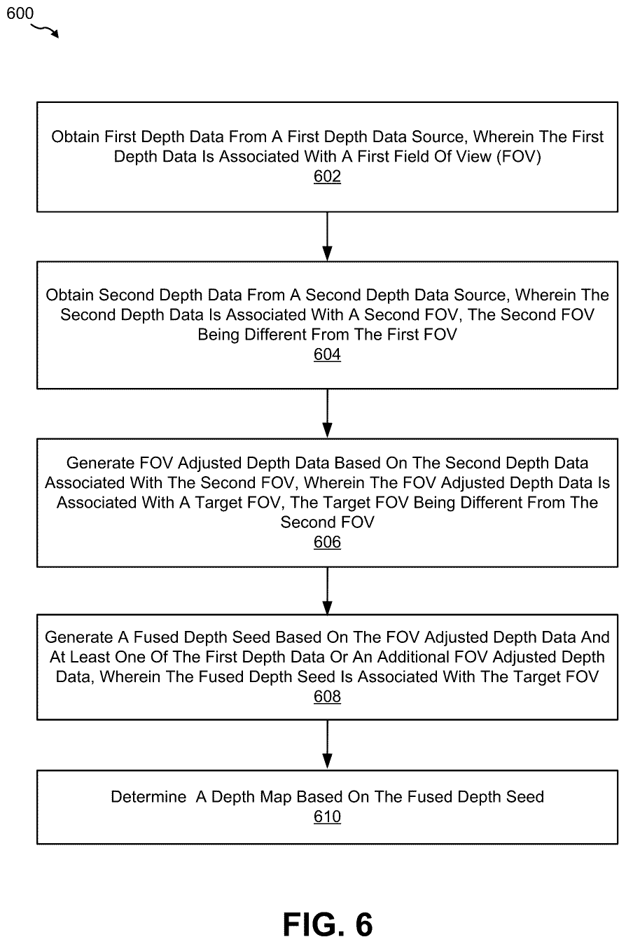

FIG. 6 is a flow diagram illustrating an example of a process 600 of wireless communication. The process 600 and/or other process described herein can be performed by a computing device (or apparatus) or a component (e.g., a chipset, codec, etc.) of the computing device. The computing device may be an extended reality (XR) device (e.g., a virtual reality (VR) device or augmented reality (AR) device), a mobile device (e.g., a mobile phone), a network-connected wearable such as a watch, a vehicle or component or system of a vehicle, or other type of computing device. In one example, the process 600 and/or other process described herein can be performed by the vehicle computing system image capture and processing system 100 of FIG. 1. In another example, one or more of the processes can be performed by the image capture device 105A shown in FIG. 1. In another example, one or more of the processes can be performed by the image processing device 105B shown in FIG. 1. In another example, one or more of the processes can be performed by the XR system 200 shown in FIG. 2. In another example, one or more of the processes can be performed by the SLAM system 300 shown in FIG. 3. In another example, one or more of the processes can be performed by the computing system 1200 shown in FIG. 12. For instance, a computing device with the computing system 1200 shown in FIG. 12 can include the components of the image capture and processing system 100, the image capture device 105A, the image processing device 105B, the XR system 200, the SLAM system 300, the depth seed fusion system 400, the depth seed fusion system 430, and/or any combination thereof and can implement the operations of the process 600 of FIG. 6 and/or other process described herein. The operations of the process 600 may be implemented as software components that are executed and run on one or more processors (e.g., the processor 1210 of FIG. 12, a processor such as a DSP, GPU, NPU, etc., or other processor(s)). Further, the transmission and reception of signals by the computing device in the process 600 may be enabled, for example, by one or more antennas, one or more transceivers (e.g., wireless transceiver(s)), and/or other communication components of the computing device (e.g., the communications interface 1240 of FIG. 12).

At block 602, the computing device (or component thereof) can obtain first depth data from a first depth data source (e.g., depth sensing systems 402 of FIG. 4A and/or depth sensing systems 402 of FIG. 4B). In some examples, the first depth data is associated with a first FOV.

At block 604, the computing device (or component thereof) can obtain second depth data from a second depth data source (e.g., depth sensing systems 402 of FIG. 4A and/or depth sensing systems 402 of FIG. 4B). In some cases, the second depth data is associated with a second FOV, the second FOV being different from the first FOV. In some implementations, the first depth data associated with the first FOV and the second depth data associated with the second FOV are obtained asynchronously.

At block 606, the computing device (or component thereof) can generate (e.g., by FOV engine 416 of FIG. 4A and/or FIG. 4B, FOV engine 516 of FIG. 5A, and/or FOV engine 536 of FIG. 5B) FOV adjusted depth data based on the second depth data associated with the second FOV. In some examples, the FOV adjusted depth data is associated with a target FOV (e.g., an FOV associated with input frame 406 of FIG. 4A and/or FIG. 4B), the target FOV being different from the second FOV. In some aspects, the target FOV is the first FOV. In some cases, the target FOV is different from the first FOV. In some cases, to generate the FOV adjusted depth data based on the second depth data associated with the second FOV, the computing device (or component thereof) can: project the second depth data from the second FOV into a 3D representation of second depth data and re-project the 3D representation of the second depth data into the target FOV.

At block 608, the computing device (or component thereof) can generate (e.g., by seed fusion engine 418 of FIG. 4A and/or FIG. 4B) a fused depth seed based on the FOV adjusted depth data and at least one of the first depth data or an additional FOV adjusted depth data. In some implementations, the fused depth seed is associated with the target FOV.

At block 610, the computing device (or component thereof) can determine (e.g., by depth engine 420 of FIG. 4A and/or FIG. 4B) a depth map based on the fused depth seed.

In some implementations, the computing device (or component thereof) can generate the additional FOV adjusted depth data based on the first depth data associated with the first FOV. In some cases, the additional FOV adjusted depth data is associated with the target FOV.

In some examples, the computing device (or component thereof) can: obtain an input frame (e.g., input frame 406 of FIG. 4A and/or FIG. 4B) associated with the target FOV and determine the depth map further based on the input frame. In some aspects, the depth map is associated with the input frame.

In some implementations, to generate the FOV adjusted depth data based on the second depth data associated with the second FOV, the computing device (or component thereof) can: filter (e.g., by a filtering module 412 of FIG. 4A and/or FIG. 4B, filtering module 512 of FIG. 5A, and/or filtering module 532 of FIG. 5B) the second depth data to remove at least one depth value associated with at least one pixel of the second depth data. In some examples, the at least one pixel is associated with the target FOV. In some examples, to filter the second depth data, the computing device (or component thereof) can: determine whether at least one of a density or a quality of the at least one depth value satisfies a filtering condition; and based on a determination that the density of the quality of the at least one depth value satisfies the filtering condition, include the at least one depth value in the FOV adjusted depth data. In some aspects, the filtering condition is associated with the second depth data source and an additional filtering condition is associated with the first depth data source, the additional filtering condition being different from the filtering condition. In some cases, the filtering condition includes a confidence mask associated with the second depth data source.

In some cases, to filter the second depth data, the computing device (or component thereof) can: determine whether a confidence value associated with the at least one depth value is less than a confidence value threshold; and based on a determination that the confidence value associated with the at least one depth value is less than the confidence value threshold, remove the at least one depth value in the FOV adjusted depth data.

In some implementations, the first depth data source includes at least one of: one or more cameras; a six degrees-of-freedom (6DoF) tracking system; a 3DoF tracking system; a Light Detection and Ranging (LiDAR) sensor; a structured light (SL) depth sensor; an indirect time of flight (iToF) sensor; a direct ToF (dToF) sensor; or a depth from stereo (DFS) system.

In some examples, the second depth data source includes at least one of: the one or more cameras; the 6DoF tracking system; the 3DoF tracking system; the LiDAR sensor; the SL depth sensor; the iToF sensor; the dToF sensor; or the DFS system.

In some cases, the target FOV is associated with a machine learning model configured to generate one or more depth maps. In some aspects, the computing device (or component thereof) can determine the depth map using the machine learning model.

The process 600 illustrated in FIG. 6 may also include any operation discussed illustrated in, or discussed with respect to, the image capture and processing system 100, the image capture device 105A, the image processing device 105B, XR system 200 of FIG. 2, SLAM system 300 of FIG. 3, depth seed fusion system 400 of FIG. 4A, depth seed fusion system 430 of FIG. 4B, block diagram 500 of FIG. 5A, block diagram 520 of FIG. 5B, or a combination thereof. The flow diagram of FIG. 6 may represent at least some of the operations of an image capture and processing system 100, an image capture device 105A, an image processing device 105B, of FIG. 1, XR system 200 of FIG. 2, SLAM system 300 of FIG. 3, depth seed fusion system 400 of FIG. 4A, depth seed fusion system 430 of FIG. 4B, block diagram 500 of FIG. 5A, block diagram 520 of FIG. 5B, an unmanned ground vehicle (UGV) 710, an unmanned aerial vehicle (UAV) 720, a head-mounted display (HMD) 810, a mobile device 950, a computing system 1200, or a combination thereof.

In some cases, at least a subset of the techniques illustrated by the process 600 may be performed remotely by one or more network servers of a cloud service. In some examples, the processes described herein (e.g., process 600, and/or other process(es) described herein) may be performed by a computing device or apparatus. In some examples, the process 600 can be performed by the image capture device 105A of FIG. 1. In some examples, the process 600 can be performed by the image processing device 105B of FIG. 1. The process 600 can also be performed by the image capture and processing system 100 of FIG. 1. In some cases, the process 600 can be performed by the XR system 200 of FIG. 2. In some implementations, the process 600 can be performed by the SLAM system 300 of FIG. 3. The process 600 can also be performed by a computing device with the architecture of the computing system 1200 shown in FIG. 12. The computing device can include any suitable device, such as a mobile device (e.g., a mobile phone), a desktop computing device, a tablet computing device, a wearable device (e.g., a VR headset, an AR headset, AR glasses, a network-connected watch or smartwatch, or other wearable device), a server computer, an autonomous vehicle or computing device of an autonomous vehicle, a robotic device, a television, and/or any other computing device with the resource capabilities to perform the processes described herein, including the process 600. In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, a network interface configured to communicate and/or receive the data, any combination thereof, and/or other component(s). The network interface may be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

The flow diagram illustrating process 600 is illustrative of, or organized as, logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the flow diagram illustrating process 600 and/or other processes described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

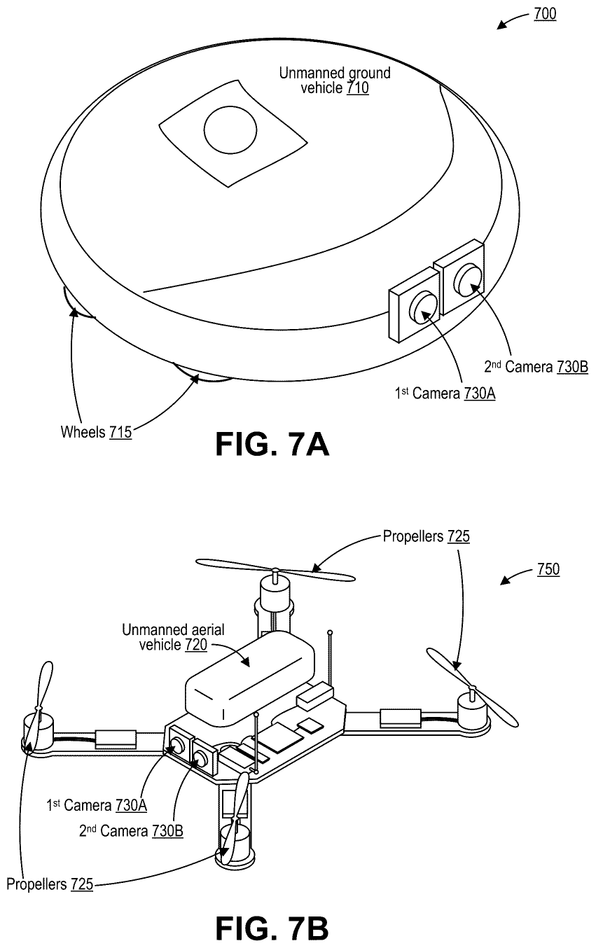

FIG. 7A is a perspective diagram 700 illustrating an unmanned ground vehicle (UGV) 710 that performs feature tracking and/or visual simultaneous localization and mapping (VSLAM), in accordance with some examples. The UGV 710 includes a first camera 730A and a second camera 730B along a front surface of the UGV 710. The first camera 730A and a second camera 730B may be two of the image capture and processing system 100 of FIG. 1, image capture device 105A of FIG. 1, image processing device 105B of FIG. 1, XR system 200 of FIG. 2, SLAM system 300 of FIG. 3, or any combination thereof. In some examples, the UGV 710 may include one or more additional cameras in addition to the first camera 730A and the second camera 730B. In some examples, the UGV 710 may include one or more additional sensors in addition to the first camera 730A and the second camera 730B. The UGV 710 includes multiple wheels 715 along a bottom surface of the UGV 710. The wheels 715 may act as a conveyance of the UGV 710, and may be motorized using one or more motors that may be actuated by a movement actuator of the UGV 710. The movement actuator, the motors, and thus the wheels 715, may be actuated to move the UGV 710 along a path.

FIG. 7B is a perspective diagram 750 illustrating an unmanned aerial vehicle (UAV) 720 that performs feature tracking and/or visual simultaneous localization and mapping (VSLAM), in accordance with some examples. The UAV 720 includes a first camera 730A and a second camera 730B along a front portion of a body of the UAV 720. The first camera 730A and a second camera 730B may be two of the image capture and processing system 100 of FIG. 1, image capture device 105A of FIG. 1, image processing device 105B of FIG. 1, XR system 200 of FIG. 2, SLAM system 300 of FIG. 3, or any combination thereof. In some examples, the UAV 720 may include one or more additional cameras in addition to the first camera 730A and the second camera 730B. In some examples, the UAV 720 may include one or more additional sensors in addition to the first camera 730A and the second camera 730B. The UAV 720 includes multiple propellers 725 along the top of the UAV 720. The propellers 725 may be spaced apart from the body of the UAV 720 by one or more appendages to prevent the propellers 725 from snagging on circuitry on the body of the UAV 720 and/or to prevent the propellers 725 from occluding the view of the first camera 730A and/or the second camera 730B. The propellers 725 may act as a conveyance of the UAV 720, and may be motorized using one or more motors that may be actuated by a movement actuator of the UAV 720. The movement actuator, the motors, and thus the propellers 725, may be actuated to move the UAV 720 along a path.

Where a SLAM system or a tracking system with a SLAM engine is a vehicle, such as the UGV 710 or UAV 720, the SLAM system may include a path planning engine and/or a movement actuator. The path planning engine may generate a path along which the vehicle is to move. In some examples, path planning engine may use a Dijkstra algorithm to plan the path. In some examples, the path planning engine may include stationary obstacle avoidance and/or moving obstacle avoidance in planning the path. In some examples, the path planning engine may include determinations as to how to best move the vehicle from a first pose to a second pose in planning the path. In some examples, the path planning engine may plan a path that is optimized to reach and observe every portion of a first region of an environment (e.g., a first set of one or more rooms in the environment) before moving on to a second region of the environment (e.g., the second set of one or more rooms of the environment) in planning the path. In some examples, the path planning engine may plan a path that is optimized to reach and observe a predetermined set of rooms in an environment (e.g., every room in the environment) as quickly as possible. In some examples, the path planning engine may plan a path that returns to a previously-observed room to observe a particular feature again to improve one or more map points corresponding the feature in the local map and/or global map (e.g., to perform a loop closure). In some examples, the path planning engine may plan a path that returns to a previously-observed room to observe a portion of the previously-observed room that lacks map points in the local map and/or global map to see if any features can be observed in that portion of the room. The movement actuator may actuate one or more motors to actuate a motorized conveyance (e.g., the wheels 715 or the propellers 725) to move the vehicle along the path planned by the path planning engine.

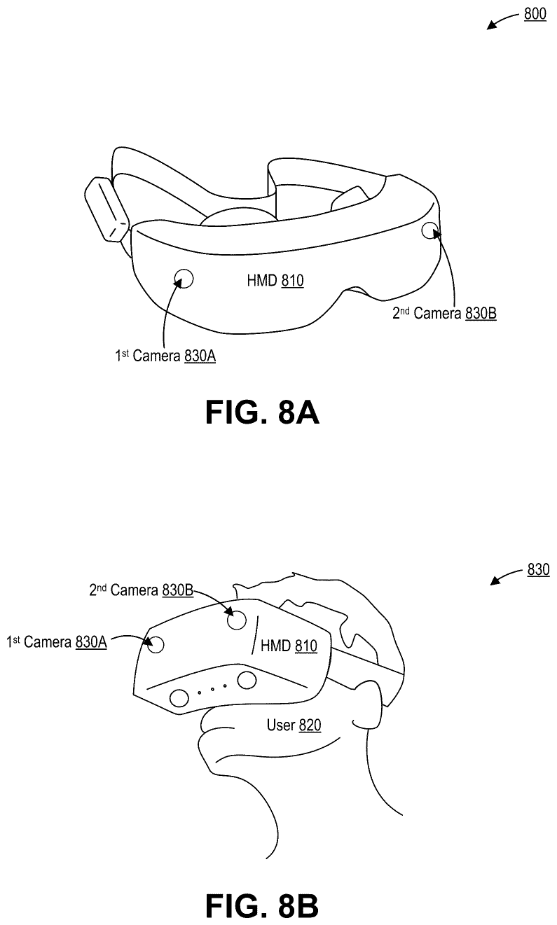

FIG. 8A is a perspective diagram 800 illustrating a head-mounted display (HMD) 810 that performs feature tracking and/or visual simultaneous localization and mapping (VSLAM), in accordance with some examples. The HMD 810 may be, for example, an augmented reality (AR) headset, a virtual reality (VR) headset, a mixed reality (MR) headset, an extended reality (XR) headset, or some combination thereof. The HMD 810 includes a first camera 830A and a second camera 830B along a front portion of the HMD 810. The first camera 830A and the second camera 830B may be two of the image capture and processing system 100 of FIG. 1, image capture device 105A of FIG. 1, image processing device 105B of FIG. 1, XR system 200 of FIG. 2, SLAM system 300 of FIG. 3, or any combination thereof. In some examples, the HMD 810 may only have a single camera. In some examples, the HMD 810 may include one or more additional cameras in addition to the first camera 830A and the second camera 830B. In some examples, the HMD 810 may include one or more additional sensors in addition to the first camera 830A and the second camera 830B.

FIG. 8B is a perspective diagram 830 illustrating the head-mounted display (HMD) 810 of FIG. 8A being worn by a user 820, in accordance with some examples. The user 820 wears the HMD 810 on the user 820's head over the user 820's eyes. The HMD 810 can capture images with the first camera 830A and the second camera 830B. In some examples, the HMD 810 displays one or more display images toward the user 820's eyes that are based on the images captured by the first camera 830A and the second camera 830B. The display images may provide a stereoscopic view of the environment, in some cases with information overlaid and/or with other modifications. For example, the HMD 810 can display a first display image to the user 820's right eye, the first display image based on an image captured by the first camera 830A. The HMD 810 can display a second display image to the user 820's left eye, the second display image based on an image captured by the second camera 830B. For instance, the HMD 810 may provide overlaid information in the display images overlaid over the images captured by the first camera 830A and the second camera 830B.

The HMD 810 includes no wheels 715, propellers 725, or other conveyance of its own. Instead, the HMD 810 relies on the movements of the user 820 to move the HMD 810 about the environment. Thus, in some cases, the HMD 810, when performing a SLAM technique, can skip path planning using a path planning engine and/or movement actuation using the movement actuator. In some cases, the HMD 810 can still perform path planning using a path planning engine, and can indicate directions to follow a suggested path to the user 820 to direct the user along the suggested path planned using the path planning engine. In some cases, for instance where the HMD 810 is a VR headset, the environment may be entirely or partially virtual. If the environment is at least partially virtual, then movement through the virtual environment may be virtual as well. For instance, movement through the virtual environment can be controlled by an input device. The movement actuator may include any such input device. Movement through the virtual environment may not require wheels 715, propellers 725, legs, or any other form of conveyance. If the environment is a virtual environment, then the HMD 810 can still perform path planning using the path planning engine and/or movement actuation. If the environment is a virtual environment, the HMD 810 can perform movement actuation using the movement actuator by performing a virtual movement within the virtual environment. Even if an environment is virtual, SLAM techniques may still be valuable, as the virtual environment can be unmapped and/or may have been generated by a device other than the HMD 810, such as a remote server or console associated with a video game or video game platform. In some cases, feature tracking and/or SLAM may be performed in a virtual environment even by vehicle or other device that has its own physical conveyance system that allows it to physically move about a physical environment.

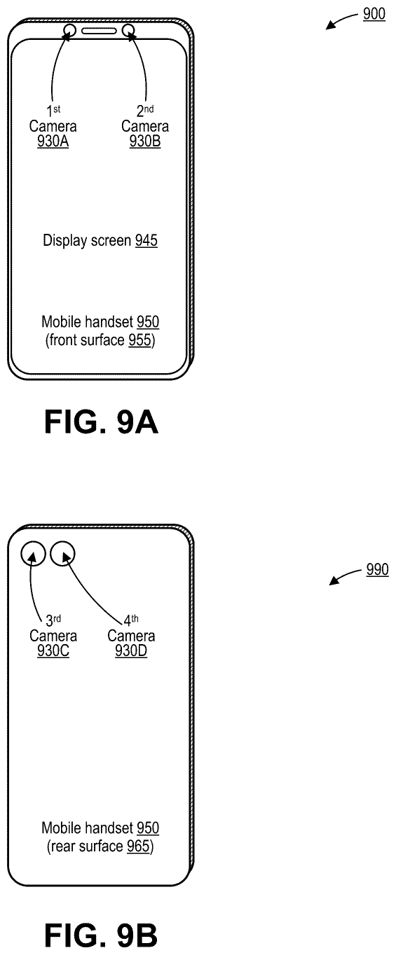

FIG. 9A is a perspective diagram 900 illustrating a front surface 955 of a mobile device 950 that performs feature tracking and/or visual simultaneous localization and mapping (VSLAM) using one or more front-facing cameras 930A-B, in accordance with some examples. The mobile device 950 may be, for example, a cellular telephone, a satellite phone, a portable gaming console, a music player, a health tracking device, a wearable device, a wireless communication device, a laptop, a mobile device, any other type of computing device or computing system 1200 discussed herein, or a combination thereof. The front surface 955 of the mobile device 950 includes a display screen 945. The front surface 955 of the mobile device 950 includes a first camera 930A and a second camera 930B. The first camera 930A and the second camera 930B are illustrated in a bezel around the display screen 945 on the front surface 955 of the mobile device 950. In some examples, the first camera 930A and the second camera 930B can be positioned in a notch or cutout that is cut out from the display screen 945 on the front surface 955 of the mobile device 950. In some examples, the first camera 930A and the second camera 930B can be under-display cameras that are positioned between the display screen 945 and the rest of the mobile device 950, so that light passes through a portion of the display screen 945 before reaching the first camera 930A and the second camera 930B. The first camera 930A and the second camera 930B of the perspective diagram 900 are front-facing cameras. The first camera 930A and the second camera 930B face a direction perpendicular to a planar surface of the front surface 955 of the mobile device 950. The first camera 930A and the second camera 930B may be two of the image capture and processing system 100 of FIG. 1, image capture device 105A of FIG. 1, image processing device 105B of FIG. 1, XR system 200 of FIG. 2, SLAM system 300 of FIG. 3, or any combination thereof. In some examples, the front surface 955 of the mobile device 950 may only have a single camera. In some examples, the mobile device 950 may include one or more additional cameras in addition to the first camera 930A and the second camera 930B. In some examples, the mobile device 950 may include one or more additional sensors in addition to the first camera 930A and the second camera 930B.

FIG. 9B is a perspective diagram 990 illustrating a rear surface 965 of a mobile device 950 that performs gaze tracking and/or visual simultaneous localization and mapping (VSLAM) using one or more rear-facing cameras 930C-D, in accordance with some examples. The mobile device 950 includes a third camera 930C and a fourth camera 930D on the rear surface 965 of the mobile device 950. The third camera 930C and the fourth camera 930D of the perspective diagram 990 are rear-facing. The third camera 930C and the fourth camera 930D face a direction perpendicular to a planar surface of the rear surface 965 of the mobile device 950. While the rear surface 965 of the mobile device 950 does not have a display screen 945 as illustrated in the perspective diagram 990, in some examples, the rear surface 965 of the mobile device 950 may have a second display screen. If the rear surface 965 of the mobile device 950 has a display screen 945, any positioning of the third camera 930C and the fourth camera 930D relative to the display screen 945 may be used as discussed with respect to the first camera 930A and the second camera 930B at the front surface 955 of the mobile device 950. The third camera 930C and the fourth camera 930D may be two of the image capture and processing system 100 of FIG. 1, image capture device 105A of FIG. 1, image processing device 105B of FIG. 1, XR system 200 of FIG. 2, SLAM system 300 of FIG. 3, or any combination thereof. In some examples, the rear surface 965 of the mobile device 950 may only have a single camera. In some examples, the mobile device 950 may include one or more additional cameras in addition to the first camera 930A, the second camera 930B, the third camera 930C, and the fourth camera 930D. In some examples, the mobile device 950 may include one or more additional sensors in addition to the first camera 930A, the second camera 930B, the third camera 930C, and the fourth camera 930D.

Like the HMD 810, the mobile device 950 includes no wheels 715, propellers 725, or other conveyance of its own. Instead, the mobile device 950 relies on the movements of a user holding or wearing the mobile device 950 to move the mobile device 950 about the environment. Thus, in some cases, the mobile device 950, when performing a SLAM technique, can skip path planning using the path planning engine and/or movement actuation using the movement actuator. In some cases, the mobile device 950 can still perform path planning using the path planning engine, and can indicate directions to follow a suggested path to the user to direct the user along the suggested path planned using the path planning engine. In some cases, for instance where the mobile device 950 is used for AR, VR, MR, or XR, the environment may be entirely or partially virtual. In some cases, the mobile device 950 may be slotted into a head-mounted device (HMD) (e.g., into a cradle of the HMD) so that the mobile device 950 functions as a display of the HMD, with the display screen 945 of the mobile device 950 functioning as the display of the HMD. If the environment is at least partially virtual, then movement through the virtual environment may be virtual as well. For instance, movement through the virtual environment can be controlled by one or more joysticks, buttons, video game controllers, mice, keyboards, trackpads, and/or other input devices that are coupled in a wired or wireless fashion to the mobile device 950. The movement actuator may include any such input device. Movement through the virtual environment may not require wheels 715, propellers 725, legs, or any other form of conveyance. If the environment is a virtual environment, then the mobile device 950 can still perform path planning using the path planning engine and/or movement actuation. If the environment is a virtual environment, the mobile device 950 can perform movement actuation using the movement actuator by performing a virtual movement within the virtual environment.

As noted above, various aspects of the present disclosure can use machine learning models or systems. FIG. 10 is an illustrative example of a deep learning neural network 1000 that can be used to implement the machine learning based feature extraction and/or activity recognition (or classification) described above. An input layer 1020 includes input data. In one illustrative example, the input layer 1020 can include data representing the pixels of an input video frame. The neural network 1000 includes multiple hidden layers 1022a, 1022b, through 1022n. The hidden layers 1022a, 1022b, through 1022n include “n” number of hidden layers, where “n” is an integer greater than or equal to one. The number of hidden layers can be made to include as many layers as needed for the given application. The neural network 1000 further includes an output layer 1021 that provides an output resulting from the processing performed by the hidden layers 1022a, 1022b, through 1022n. In one illustrative example, the output layer 1021 can provide a classification for an object in an input video frame. The classification can include a class identifying the type of activity (e.g., looking up, looking down, closing eyes, yawning, etc.).

The neural network 1000 is a multi-layer neural network of interconnected nodes. Each node can represent a piece of information. Information associated with the nodes is shared among the different layers and each layer retains information as information is processed. In some cases, the neural network 1000 can include a feed-forward network, in which case there are no feedback connections where outputs of the network are fed back into itself. In some cases, the neural network 1000 can include a recurrent neural network, which can have loops that allow information to be carried across nodes while reading in input.

Information can be exchanged between nodes through node-to-node interconnections between the various layers. Nodes of the input layer 1020 can activate a set of nodes in the first hidden layer 1022a. For example, as shown, each of the input nodes of the input layer 1020 is connected to each of the nodes of the first hidden layer 1022a. The nodes of the first hidden layer 1022a can transform the information of each input node by applying activation functions to the input node information. The information derived from the transformation can then be passed to and can activate the nodes of the next hidden layer 1022b, which can perform their own designated functions. Example functions include convolutional, up-sampling, data transformation, and/or any other suitable functions. The output of the hidden layer 1022b can then activate nodes of the next hidden layer, and so on. The output of the last hidden layer 1022n can activate one or more nodes of the output layer 1021, at which an output is provided. In some cases, while nodes (e.g., node 1026) in the neural network 1000 are shown as having multiple output lines, a node has a single output and all lines shown as being output from a node represent the same output value.

In some cases, each node or interconnection between nodes can have a weight that is a set of parameters derived from the training of the neural network 1000. Once the neural network 1000 is trained, it can be referred to as a trained neural network, which can be used to classify one or more activities. For example, an interconnection between nodes can represent a piece of information learned about the interconnected nodes. The interconnection can have a tunable numeric weight that can be tuned (e.g., based on a training dataset), allowing the neural network 1000 to be adaptive to inputs and able to learn as more and more data is processed.

The neural network 1000 is pre-trained to process the features from the data in the input layer 1020 using the different hidden layers 1022a, 1022b, through 1022n in order to provide the output through the output layer 1021. In an example in which the neural network 1000 is used to identify activities being performed by a driver in frames, the neural network 1000 can be trained using training data that includes both frames and labels, as described above. For instance, training frames can be input into the network, with each training frame having a label indicating the features in the frames (for the feature extraction machine learning system) or a label indicating classes of an activity in each frame. In one example using object classification for illustrative purposes, a training frame can include an image of a number 2, in which case the label for the image can be [0 0 1 0 0 0 0 0 0 0].

In some cases, the neural network 1000 can adjust the weights of the nodes using a training process called backpropagation. As noted above, a backpropagation process can include a forward pass, a loss function, a backward pass, and a weight update. The forward pass, loss function, backward pass, and parameter update is performed for one training iteration. The process can be repeated for a certain number of iterations for each set of training images until the neural network 1000 is trained well enough so that the weights of the layers are accurately tuned.

For the example of identifying objects in frames, the forward pass can include passing a training frame through the neural network 1000. The weights are initially randomized before the neural network 1000 is trained. As an illustrative example, a frame can include an array of numbers representing the pixels of the image. Each number in the array can include a value from 0 to 255 describing the pixel intensity at that position in the array. In one example, the array can include a 28×28×3 array of numbers with 28 rows and 28 columns of pixels and 3 color components (such as red, green, and blue, or luma and two chroma components, or the like).

As noted above, for a first training iteration for the neural network 1000, the output will likely include values that do not give preference to any particular class due to the weights being randomly selected at initialization. For example, if the output is a vector with probabilities that the object includes different classes, the probability value for each of the different classes may be equal or at least very similar (e.g., for ten possible classes, each class may have a probability value of 0.1). With the initial weights, the neural network 1000 is unable to determine low level features and thus cannot make an accurate determination of what the classification of the object might be. A loss function can be used to analyze error in the output. Any suitable loss function definition can be used, such as a Cross-Entropy loss. Another example of a loss function includes the mean squared error (MSE), defined as

$${E}_{total} = \sum \frac{1}{2} {( target - output )}^{2} .$$

The loss can be set to be equal to the value of Eₜₒₜₐₗ.

The loss (or error) will be high for the first training images since the actual values will be much different than the predicted output. The goal of training is to minimize the amount of loss so that the predicted output is the same as the training label. The neural network 1000 can perform a backward pass by determining which inputs (weights) most contributed to the loss of the network, and can adjust the weights so that the loss decreases and is eventually minimized. A derivative of the loss with respect to the weights (denoted as dL/dW, where W are the weights at a particular layer) can be computed to determine the weights that contributed most to the loss of the network. After the derivative is computed, a weight update can be performed by updating all the weights of the filters. For example, the weights can be updated so that they change in the opposite direction of the gradient. The weight update can be denoted as

$$w = {w}_{i} - η \frac{d L}{d W} ,$$

where w denotes a weight, wᵢ denotes the initial weight, and n denotes a learning rate. The learning rate can be set to any suitable value, with a high learning rate including larger weight updates and a lower value indicating smaller weight updates.

The neural network 1000 can include any suitable deep network. One example includes a convolutional neural network (CNN), which includes an input layer and an output layer, with multiple hidden layers between the input and out layers. The hidden layers of a CNN include a series of convolutional, nonlinear, pooling (for downsampling), and fully connected layers. The neural network 1000 can include any other deep network other than a CNN, such as an autoencoder, a deep belief nets (DBNs), a Recurrent Neural Networks (RNNs), among others.

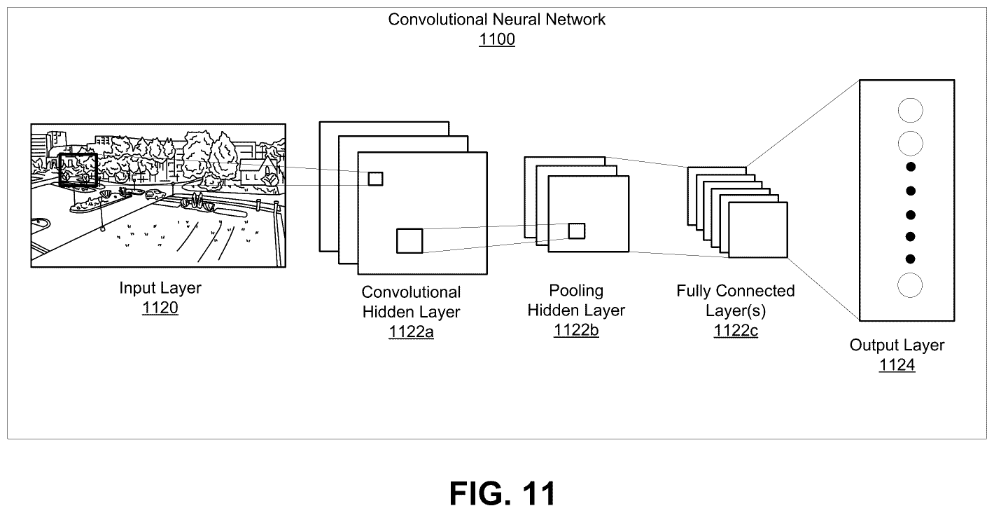

FIG. 11 is an illustrative example of a convolutional neural network (CNN) 1100. The input layer 1120 of the CNN 1100 includes data representing an image or frame. For example, the data can include an array of numbers representing the pixels of the image, with each number in the array including a value from 0 to 255 describing the pixel intensity at that position in the array. Using the previous example from above, the array can include a 28×28×3 array of numbers with 28 rows and 28 columns of pixels and 3 color components (e.g., red, green, and blue, or luma and two chroma components, or the like). The image can be passed through a convolutional hidden layer 1122a, an optional non-linear activation layer, a pooling hidden layer 1122b, and fully connected hidden layers 1122c to get an output at the output layer 1124. While only one of each hidden layer is shown in FIG. 11, one of ordinary skill will appreciate that multiple convolutional hidden layers, non-linear layers, pooling hidden layers, and/or fully connected layers can be included in the CNN 1100. As previously described, the output can indicate a single class of an object or can include a probability of classes that best describe the object in the image.

The first layer of the CNN 1100 is the convolutional hidden layer 1122a. The convolutional hidden layer 1122a analyzes the image data of the input layer 1120. Each node of the convolutional hidden layer 1122a is connected to a region of nodes (pixels) of the input image called a receptive field. The convolutional hidden layer 1122a can be considered as one or more filters (each filter corresponding to a different activation or feature map), with each convolutional iteration of a filter being a node or neuron of the convolutional hidden layer 1122a. For example, the region of the input image that a filter covers at each convolutional iteration would be the receptive field for the filter. In one illustrative example, if the input image includes a 28×28 array, and each filter (and corresponding receptive field) is a 5×5 array, then there will be 24×24 nodes in the convolutional hidden layer 1122a. Each connection between a node and a receptive field for that node learns a weight and, in some cases, an overall bias such that each node learns to analyze its particular local receptive field in the input image. Each node of the hidden layer 1122a will have the same weights and bias (called a shared weight and a shared bias). For example, the filter has an array of weights (numbers) and the same depth as the input. A filter will have a depth of 3 for the video frame example (according to three color components of the input image). An illustrative example size of the filter array is 5×5×3, corresponding to a size of the receptive field of a node.

The convolutional nature of the convolutional hidden layer 1122a is due to each node of the convolutional layer being applied to its corresponding receptive field. For example, a filter of the convolutional hidden layer 1122a can begin in the top-left corner of the input image array and can convolve around the input image. As noted above, each convolutional iteration of the filter can be considered a node or neuron of the convolutional hidden layer 1122a. At each convolutional iteration, the values of the filter are multiplied with a corresponding number of the original pixel values of the image (e.g., the 5×5 filter array is multiplied by a 5×5 array of input pixel values at the top-left corner of the input image array). The multiplications from each convolutional iteration can be summed together to obtain a total sum for that iteration or node. The process is next continued at a next location in the input image according to the receptive field of a next node in the convolutional hidden layer 1122a. For example, a filter can be moved by a step amount (referred to as a stride) to the next receptive field. The stride can be set to 1 or other suitable amount. For example, if the stride is set to 1, the filter will be moved to the right by 1 pixel at each convolutional iteration. Processing the filter at each unique location of the input volume produces a number representing the filter results for that location, resulting in a total sum value being determined for each node of the convolutional hidden layer 1122a.

The mapping from the input layer to the convolutional hidden layer 1122a is referred to as an activation map (or feature map). The activation map includes a value for each node representing the filter results at each locations of the input volume. The activation map can include an array that includes the various total sum values resulting from each iteration of the filter on the input volume. For example, the activation map will include a 24×24 array if a 5×5 filter is applied to each pixel (a stride of 1) of a 28×28 input image. The convolutional hidden layer 1122a can include several activation maps in order to identify multiple features in an image. The example shown in FIG. 11 includes three activation maps. Using three activation maps, the convolutional hidden layer 1122a can detect three different kinds of features, with each feature being detectable across the entire image.

In some examples, a non-linear hidden layer can be applied after the convolutional hidden layer 1122a. The non-linear layer can be used to introduce non-linearity to a system that has been computing linear operations. One illustrative example of a non-linear layer is a rectified linear unit (ReLU) layer. A ReLU layer can apply the function ƒ(x)=max(0, x) to all of the values in the input volume, which changes all the negative activations to 0. The ReLU can thus increase the non-linear properties of the CNN 1100 without affecting the receptive fields of the convolutional hidden layer 1122a.

The pooling hidden layer 1122b can be applied after the convolutional hidden layer 1122a (and after the non-linear hidden layer when used). The pooling hidden layer 1122b is used to simplify the information in the output from the convolutional hidden layer 1122a. For example, the pooling hidden layer 1122b can take each activation map output from the convolutional hidden layer 1122a and generates a condensed activation map (or feature map) using a pooling function. Max-pooling is one example of a function performed by a pooling hidden layer. Other forms of pooling functions be used by the pooling hidden layer 1122a, such as average pooling, L2-norm pooling, or other suitable pooling functions. A pooling function (e.g., a max-pooling filter, an L2-norm filter, or other suitable pooling filter) is applied to each activation map included in the convolutional hidden layer 1122a. In the example shown in FIG. 11, three pooling filters are used for the three activation maps in the convolutional hidden layer 1122a.

In some examples, max-pooling can be used by applying a max-pooling filter (e.g., having a size of 2×2) with a stride (e.g., equal to a dimension of the filter, such as a stride of 2) to an activation map output from the convolutional hidden layer 1122a. The output from a max-pooling filter includes the maximum number in every sub-region that the filter convolves around. Using a 2×2 filter as an example, each unit in the pooling layer can summarize a region of 2×2 nodes in the previous layer (with each node being a value in the activation map). For example, four values (nodes) in an activation map will be analyzed by a 2×2 max-pooling filter at each iteration of the filter, with the maximum value from the four values being output as the “max” value. If such a max-pooling filter is applied to an activation filter from the convolutional hidden layer 1122a having a dimension of 24×24 nodes, the output from the pooling hidden layer 1122b will be an array of 12×12 nodes.

In some examples, an L2-norm pooling filter could also be used. The L2-norm pooling filter includes computing the square root of the sum of the squares of the values in the 2×2 region (or other suitable region) of an activation map (instead of computing the maximum values as is done in max-pooling), and using the computed values as an output.

Intuitively, the pooling function (e.g., max-pooling, L2-norm pooling, or other pooling function) determines whether a given feature is found anywhere in a region of the image, and discards the exact positional information. This can be done without affecting results of the feature detection because, once a feature has been found, the exact location of the feature is not as important as its approximate location relative to other features. Max-pooling (as well as other pooling methods) offer the benefit that there are many fewer pooled features, thus reducing the number of parameters needed in later layers of the CNN 1100.

The final layer of connections in the network is a fully-connected layer that connects every node from the pooling hidden layer 1122b to every one of the output nodes in the output layer 1124. Using the example above, the input layer includes 28×28 nodes encoding the pixel intensities of the input image, the convolutional hidden layer 1122a includes 3×24×24 hidden feature nodes based on application of a 5×5 local receptive field (for the filters) to three activation maps, and the pooling hidden layer 1122b includes a layer of 3×12×12 hidden feature nodes based on application of max-pooling filter to 2×2 regions across each of the three feature maps. Extending this example, the output layer 1124 can include ten output nodes. In such an example, every node of the 3×12×12 pooling hidden layer 1122b is connected to every node of the output layer 1124.

The fully connected layer 1122c can obtain the output of the previous pooling hidden layer 1122b (which should represent the activation maps of high-level features) and determines the features that most correlate to a particular class. For example, the fully connected layer 1122c layer can determine the high-level features that most strongly correlate to a particular class, and can include weights (nodes) for the high-level features. A product can be computed between the weights of the fully connected layer 1122c and the pooling hidden layer 1122b to obtain probabilities for the different classes. For example, if the CNN 1100 is being used to predict that an object in a video frame is a person, high values will be present in the activation maps that represent high-level features of people (e.g., two legs are present, a face is present at the top of the object, two eyes are present at the top left and top right of the face, a nose is present in the middle of the face, a mouth is present at the bottom of the face, and/or other features common for a person).

In some examples, the output from the output layer 1124 can include an M-dimensional vector (in the prior example, M=10). M indicates the number of classes that the CNN 1100 has to choose from when classifying the object in the image. Other example outputs can also be provided. Each number in the M-dimensional vector can represent the probability the object is of a certain class. In one illustrative example, if a 10-dimensional output vector represents ten different classes of objects is [0 0 0.05 0.8 0 0.15 0 0 0 0], the vector indicates that there is a 5% probability that the image is the third class of object (e.g., a dog), an 80% probability that the image is the fourth class of object (e.g., a human), and a 15% probability that the image is the sixth class of object (e.g., a kangaroo). The probability for a class can be considered a confidence level that the object is part of that class.

FIG. 12 is a diagram illustrating an example of a system for implementing certain aspects of the present technology. In particular, FIG. 12 illustrates an example of computing system 1200, which can be for example any computing device making up the image capture and processing system 100, the image capture device 105A, the image processing device 105B, image capture and processing system 170 or any component thereof in which the components of the system are in communication with each other using connection 1205. Connection 1205 can be a physical connection using a bus, or a direct connection into processor 1210, such as in a chipset architecture. Connection 1205 can also be a virtual connection, networked connection, or logical connection.

In some embodiments, computing system 1200 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example computing system 1200 includes at least one processing unit (CPU or processor) 1210 and connection 1205 that couples various system components including system memory 1215, such as read-only memory (ROM) 1220 and random access memory (RAM) 1225 to processor 1210. Computing system 1200 can include a cache 1212 of high-speed memory connected directly with, in close proximity to, or integrated as part of processor 1210.

Processor 1210 can include any general purpose processor and a hardware service or software service, such as services 1232, 1234, and 1236 stored in storage device 1230, configured to control processor 1210 as well as a special-purpose processor where software instructions are incorporated into the actual processor design. Processor 1210 may essentially be a completely self-contained computing system, containing multiple cores or processors, a bus, memory controller, cache, etc. A multi-core processor may be symmetric or asymmetric.

To enable user interaction, computing system 1200 includes an input device 1245, which can represent any number of input mechanisms, such as a microphone for speech, a touch-sensitive screen for gesture or graphical input, keyboard, mouse, motion input, speech, etc. Computing system 1200 can also include output device 1235, which can be one or more of a number of output mechanisms. In some instances, multimodal systems can enable a user to provide multiple types of input/output to communicate with computing system 1200. Computing system 1200 can include communications interface 1240, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 1240 may also include one or more Global Navigation Satellite System (GNSS) receivers or transceivers that are used to determine a location of the computing system 1200 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1230 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L #), resistive random-access memory (RRAM/ReRAM), phase change memory (PCM), spin transfer torque RAM (STT-RAM), another memory chip or cartridge, and/or a combination thereof.

The storage device 1230 can include software services, servers, services, etc., that when the code that defines such software is executed by the processor 1210, it causes the system to perform a function. In some embodiments, a hardware service that performs a particular function can include the software component stored in a computer-readable medium in connection with the necessary hardware components, such as processor 1210, connection 1205, output device 1235, etc., to carry out the function.

As used herein, the term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted using any suitable means including memory sharing, message passing, token passing, network transmission, or the like.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the embodiments and examples provided herein. However, it will be understood by one of ordinary skill in the art that the embodiments may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Individual embodiments may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific embodiments thereof, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” means A, B, or A and B. In another example, claim language reciting “at least one of A, B, and C” means A, B, C, or A and B, or A and C, or B and C, or A and B and C. The language “at least one of” a set and/or “one or more” of a set does not limit the set to the items listed in the set. For example, claim language reciting “at least one of A and B” can mean A, B, or A and B, and can additionally include items not listed in the set of A and B.

The various illustrative logical blocks, modules, circuits, and algorithm steps described in connection with the embodiments disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

Illustrative aspects of the disclosure include:

Aspect 1: An apparatus for image processing, the apparatus comprising: at least one memory; and at least one processor coupled to the at least one memory and configured to: obtain first depth data from a first depth data source, wherein the first depth data is associated with a first field of view (FOV); obtain second depth data from a second depth data source, wherein the second depth data is associated with a second FOV, the second FOV being different from the first FOV; generate FOV adjusted depth data based on the second depth data associated with the second FOV, wherein the FOV adjusted depth data is associated with a target FOV, the target FOV being different from the second FOV; generate a fused depth seed based on the FOV adjusted depth data and at least one of the first depth data or an additional FOV adjusted depth data, wherein the fused depth seed is associated with the target FOV; and determine a depth map based on the fused depth seed.

Aspect 2: The apparatus of Aspect 1, wherein the target FOV is the first FOV.

Aspect 3: The apparatus of any one of Aspects 1 to 2, wherein the target FOV is different from the first FOV.

Aspect 4: The apparatus of any one of Aspects 1 to 3, wherein the at least one processor is further configured to generate the additional FOV adjusted depth data based on the first depth data associated with the first FOV, wherein the additional FOV adjusted depth data is associated with the target FOV.

Aspect 5: The apparatus of any one of Aspects 1 to 4, wherein, to generate the FOV adjusted depth data based on the second depth data associated with the second FOV, the at least one processor is configured to: project the second depth data from the second FOV into a three-dimensional (3D) representation of second depth data; and re-project the 3D representation of the second depth data into the target FOV.

Aspect 6: The apparatus of any one of Aspects 1 to 5, wherein the at least one processor is further configured to: obtain an input frame associated with the target FOV; and determine the depth map further based on the input frame, wherein the depth map is associated with the input frame.

Aspect 7: The apparatus of any one of Aspects 1 to 6, wherein, to generate the FOV adjusted depth data based on the second depth data associated with the second FOV, the at least one processor is configured to filter the second depth data to remove at least one depth value associated with at least one pixel of the second depth data, wherein the at least one pixel is associated with the target FOV.

Aspect 8: The apparatus of Aspect 7, wherein, to filter the second depth data, the at least one processor is configured to: determine whether at least one of a density or a quality of the at least one depth value satisfies a filtering condition; and based on a determination that the density of the quality of the at least one depth value satisfies the filtering condition, including the at least one depth value in the FOV adjusted depth data.

Aspect 9: The apparatus of Aspect 7, wherein, to filter the second depth data, the at least one processor is configured to: determine whether a confidence value associated with the at least one depth value is less than a confidence value threshold; and based on a determination that the confidence value associated with the at least one depth value is less than the confidence value threshold, removing the at least one depth value in the FOV adjusted depth data.

Aspect 10: The apparatus of Aspect 8, wherein the filtering condition is associated with the second depth data source and an additional filtering condition is associated with the first depth data source, the additional filtering condition being different from the filtering condition.

Aspect 11: The apparatus of Aspect 8, wherein the filtering condition comprises a confidence mask associated with the second depth data source.

Aspect 12: The apparatus of any one of Aspects 1 to 11, wherein the first depth data source comprises at least one of: one or more cameras; a six degrees-of-freedom (6DoF) tracking system; a 3DoF tracking system; a Light Detection and Ranging (LiDAR) sensor; a structured light (SL) depth sensor; an indirect time of flight (iToF) sensor; a direct ToF (dToF) sensor; or a depth from stereo (DFS) system.

Aspect 13: The apparatus of Aspect 12, wherein the second depth data source comprises at least one of: the one or more cameras; the 6DoF tracking system; the 3DoF tracking system; the LiDAR sensor; the SL depth sensor; the iToF sensor; the dToF sensor; or the DFS system.

Aspect 14: The apparatus of any one of Aspects 1 to 13, wherein the target FOV is associated with a machine learning model configured to generate one or more depth maps.

Aspect 15: The apparatus of Aspect 14, wherein the at least one processor is configured to determine the depth map using the machine learning model.

Aspect 16: The apparatus of any one of Aspects 1 to 15, wherein the first depth data associated with the first FOV and the second depth data associated with the second FOV are obtained asynchronously.

Aspect 17: A method comprising: obtaining first depth data from a first depth data source, wherein the first depth data is associated with a first FOV; obtaining second depth data from a second depth data source, wherein the second depth data is associated with a second FOV, the second FOV being different from the first FOV; generating FOV adjusted depth data based on the second depth data associated with the second FOV, wherein the FOV adjusted depth data is associated with a target FOV, the target FOV being different from the second FOV; generating a fused depth seed based on the FOV adjusted depth data and at least one of the first depth data or an additional FOV adjusted depth data, wherein the fused depth seed is associated with the target FOV; and determining a depth map based on the fused depth seed.

Aspect 18: The method of Aspect 17, wherein the target FOV is the first FOV.

Aspect 19: The method of any one of Aspects 17 to 18, wherein the target FOV is different from the first FOV.

Aspect 20: The method of any one of Aspects 17 to 19, further comprising generating the additional FOV adjusted depth data based on the first depth data associated with the first FOV, wherein the additional FOV adjusted depth data is associated with the target FOV.

Aspect 21: The method of any one of Aspects 17 to 20, wherein generating the FOV adjusted depth data based on the second depth data associated with the second FOV comprises: projecting the second depth data from the second FOV into a 3D representation of second depth data; and re-projecting the 3D representation of the second depth data into the target FOV.

Aspect 22: The method of any one of Aspects 17 to 21, further comprising: obtaining an input frame associated with the target FOV; and determining the depth map further based on the input frame, wherein the depth map is associated with the input frame.

Aspect 23: The method of any one of Aspects 17 to 22, wherein generating the FOV adjusted depth data based on the second depth data associated with the second FOV comprises filtering the second depth data to remove at least one depth value associated with at least one pixel of the second depth data, wherein the at least one pixel is associated with the target FOV.

Aspect 24: The method of Aspect 23, wherein filtering the second depth data comprises: determining whether at least one of a density or a quality of the at least one depth value satisfies a filtering condition; and including, based on determining that the density of the quality of the at least one depth value satisfies the filtering condition, the at least one depth value in the FOV adjusted depth data.

Aspect 25: The method of Aspect 24, wherein the filtering condition is associated with the second depth data source and an additional filtering condition is associated with the first depth data source, the additional filtering condition being different from the filtering condition.

Aspect 26: The method of Aspect 24, wherein the filtering condition comprises a confidence mask associated with the second depth data source.

Aspect 27: The method of Aspect 23, wherein filtering the second depth data further comprises: determining whether a confidence value associated with the at least one depth value is less than a confidence value threshold; and removing, based on a determination that the confidence value associated with the at least one depth value is less than the confidence value threshold, the at least one depth value in the FOV adjusted depth data.

Aspect 28: The method of any one of Aspects 17 to 27, wherein the first depth data source comprises at least one of: one or more cameras; a 6DoF tracking system; a 3DoF tracking system; a LiDAR sensor; a SL depth sensor; an iToF sensor; a dToF sensor; or a DFS system.

Aspect 29: The method of Aspect 28, wherein the second depth data source comprises at least one of: the one or more cameras; the 6DoF tracking system; the 3DoF tracking system; the LiDAR sensor; the SL depth sensor; the iToF sensor; the dToF sensor; or the DFS system.

Aspect 30: The method of any one of Aspects 17 to 28, wherein the target FOV is associated with a machine learning model configured to generate one or more depth maps.

Aspect 31: The method of Aspect 14, wherein the at least one processor is configured to determine the depth map using the machine learning model.

Aspect 32: The method of any one of Aspects 17 to 31, wherein the first depth data associated with the first FOV and the second depth data associated with the second FOV are obtained asynchronously.

Aspect 33: A non-transitory computer-readable storage medium having stored thereon instructions which, when executed by one or more processors, cause the one or more processors to perform any of the operations of aspects 1 to 32.

Aspect 34: An apparatus comprising means for performing any of the operations of aspects 1 to 32.

What is claimed is:

1. An apparatus for estimating depth, the apparatus comprising:
at least one memory; and
at least one processor coupled to the at least one memory and configured to:
obtain first depth data from a first depth data source, wherein the first depth data is associated with a first field of view (FOV);
obtain second depth data from a second depth data source, wherein the second depth data is associated with a second FOV, the second FOV being different from the first FOV;
generate FOV adjusted depth data based on the second depth data associated with the second FOV, wherein the FOV adjusted depth data is associated with a target FOV, the target FOV being different from the second FOV;
generate a fused depth seed based on the FOV adjusted depth data and at least one of the first depth data or an additional FOV adjusted depth data, wherein the fused depth seed is associated with the target FOV; and
determine a depth map based on the fused depth seed.

2. The apparatus of claim 1, wherein the target FOV is the first FOV.

3. The apparatus of claim 1, wherein the target FOV is different from the first FOV.

4. The apparatus of claim 1, wherein the at least one processor is further configured to generate the additional FOV adjusted depth data based on the first depth data associated with the first FOV, wherein the additional FOV adjusted depth data is associated with the target FOV.

5. The apparatus of claim 1, wherein, to generate the FOV adjusted depth data based on the second depth data associated with the second FOV, the at least one processor is configured to:
project the second depth data from the second FOV into a three-dimensional (3D) representation of second depth data; and
re-project the 3D representation of the second depth data into the target FOV.

6. The apparatus of claim 1, wherein the at least one processor is further configured to:
obtain an input frame associated with the target FOV; and
determine the depth map further based on the input frame, wherein the depth map is associated with the input frame.

7. The apparatus of claim 1, wherein, to generate the FOV adjusted depth data based on the second depth data associated with the second FOV, the at least one processor is configured to filter the second depth data to remove at least one depth value associated with at least one pixel of the second depth data, wherein the at least one pixel is associated with the target FOV.

8. The apparatus of claim 7, wherein, to filter the second depth data, the at least one processor is configured to:
determine whether at least one of a density or a quality of the at least one depth value satisfies a filtering condition; and
based on a determination that the density of the quality of the at least one depth value satisfies the filtering condition, include the at least one depth value in the FOV adjusted depth data.

9. The apparatus of claim 8, wherein the filtering condition is associated with the second depth data source and an additional filtering condition is associated with the first depth data source, the additional filtering condition being different from the filtering condition.

10. The apparatus of claim 8, wherein the filtering condition comprises a confidence mask associated with the second depth data source.

11. The apparatus of claim 7, wherein, to filter the second depth data, the at least one processor is configured to:
determine whether a confidence value associated with the at least one depth value is less than a confidence value threshold; and
based on a determination that the confidence value associated with the at least one depth value is less than the confidence value threshold, remove the at least one depth value in the FOV adjusted depth data.

12. The apparatus of claim 1, wherein the first depth data source comprises at least one of:
one or more cameras;
a six degrees-of-freedom (6DoF) tracking system;
a 3DoF tracking system;
a Light Detection and Ranging (LiDAR) sensor;
a structured light (SL) depth sensor;
an indirect time of flight (iToF) sensor;
a direct ToF (dToF) sensor; or
a depth from stereo (DFS) system.

13. The apparatus of claim 12, wherein the second depth data source comprises at least one of:
the one or more cameras;
the 6DoF tracking system;
the 3DoF tracking system;
the LiDAR sensor;
the SL depth sensor;
the iToF sensor;
the dToF sensor; or
the DFS system.

14. The apparatus of claim 1, wherein the target FOV is associated with a machine learning model configured to generate one or more depth maps.

15. The apparatus of claim 14, wherein the at least one processor is configured to determine the depth map using the machine learning model.

16. The apparatus of claim 1, wherein the first depth data associated with the first FOV and the second depth data associated with the second FOV are obtained asynchronously.

17. A method for estimating depth comprising:
obtaining first depth data from a first depth data source, wherein the first depth data is associated with a first FOV;
obtaining second depth data from a second depth data source, wherein the second depth data is associated with a second FOV, the second FOV being different from the first FOV;
generating FOV adjusted depth data based on the second depth data associated with the second FOV, wherein the FOV adjusted depth data is associated with a target FOV, the target FOV being different from the second FOV;
generating a fused depth seed based on the FOV adjusted depth data and at least one of the first depth data or an additional FOV adjusted depth data, wherein the fused depth seed is associated with the target FOV; and
determining a depth map based on the fused depth seed.

18. The method of claim 17, wherein the target FOV is the first FOV.

19. The method of claim 17, wherein the target FOV is different from the first FOV.

20. The method of claim 17, further comprising generating the additional FOV adjusted depth data based on the first depth data associated with the first FOV, wherein the additional FOV adjusted depth data is associated with the target FOV.
